(19) United States
(12) Patent Application Publication
(10) Pub. No.: US 2026/0195934 A1
(43) Pub. Date: Jul. 9, 2026

(54) ATTENTION-BASED NOISE SEED SELECTION FOR VIDEO DIFFUSION MODELS

(71) Applicant: Intel Corporation, Santa Clara, CA (US)

(72) Inventors: Somdeb Majumdar, Mission Viejo, CA (US); Sainan Liu, San Diego, CA (US); Hector Ayala Valdez, El Dorado Hills, CA (US); Tz-Ying Wu, San Diego, CA (US); Subarna Tripathi, San Diego, CA (US)

(73) Assignee: Intel Corporation, Santa Clara, CA (US)

(21) Appl. No.: 19/557,835

(22) Filed: Mar. 5, 2026

(51) Int. Cl. G06T 11/00

(52) U.S. Cl. CPC G06T 11/00

(57) ABSTRACT

Systems, apparatus, articles of manufacture, and methods to implement attention-based noise seed selection for video diffusion models are disclosed. An example system selects an initial noise seed for a trained video diffusion model using attention data generated by the model. In some examples, the system generates multiple candidate noise seeds, runs the video diffusion model for a small number of iterations with each candidate, and extracts attention maps from one or more attention layers of the model. For each candidate seed, the system computes a similarity or difference score between the candidate's attention map(s) and those of the other candidates. The seed having the most consistent attention pattern is selected and then used to drive the remaining diffusion iterations to produce a synthetic video. The approach involves no model retraining, incurs low computational overhead, and can display interpretable attention heat maps for user inspection.

### BACKGROUND

A video diffusion model is a generative artificial intelligence (AI) model trained to generate, or infer, an output video sequence based on a sequence of noise samples and one or more other inputs applied to the model. The sequence of noise samples is generated based on a noise schedule initialized by a noise seed. The video diffusion model is trained to iteratively denoise the noise samples to generate, or infer, an output video sequence that attempts to satisfy the one or more other inputs applied to the model.

### BRIEF DESCRIPTION OF THE DRAWINGS

FIG. 1 is a block diagram of an example video generation system including example noise seed selection circuitry to select a noise seed for a video diffusion model based on attention in accordance with teachings of this disclosure.

FIG. 2 is a block diagram of an example implementation of the noise seed selection circuitry of FIG. 1.

FIG. 3 illustrates example videos generated by the example video diffusion model of FIG. 1 using different noise seeds selected by the example noise seed selection circuitry of FIGS. 1 and/or 2.

FIGS. 4-6 are flowcharts representative of example machine-readable instructions and/or example operations that may be executed, instantiated, and/or performed by example programmable circuitry to implement the noise seed selection circuitry of FIG. 2.

FIG. 7 is a block diagram of an example processing platform including programmable circuitry structured to execute, instantiate, and/or perform the example machine-readable instructions and/or perform the example operations of FIGS. 4-6 to implement the noise seed selection circuitry of FIG. 2.

FIG. 8 is a block diagram of an example implementation of the programmable circuitry of FIG. 7.

FIG. 9 is a block diagram of another example implementation of the programmable circuitry of FIG. 7.

FIG. 10 is a block diagram of an example software/firmware/instructions distribution platform (e.g., one or more servers) to distribute software, instructions, and/or firmware (e.g., corresponding to the example machine-readable instructions of FIGS. 4-6) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

### DETAILED DESCRIPTION

A video diffusion model is a type of generative AI model trained to synthesize or, in other words, infer or generate videos from noise (e.g., noise data) by learning an iterative denoising process to reverse an iterative noise addition process performed during model training. Some video diffusion models operate in pixel space and work on noise data having the dimensions of the output video sequence. For example, assume the synthetic video output from the video diffusion model is to have a frame resolution of H height pixels by W width pixels and include F total frames. In such an example, a video diffusion model that operates in the pixel space may process noise data having dimensions H×W×F, corresponding to F noise frames having a resolution of H×W noise samples. However, some video diffusion models, referred to as latent video diffusion models, operate in latent space and, thus, work on noise data having a reduced dimensionality relative to the output synthetic video. For example, a latent video diffusion model may be trained to operate on noise data having dimensions H′×W′×F, corresponding to F noise frames having a reduced resolution of H′×W′ noise samples, with the latent height dimension H′ being some fraction of the pixel height dimension H, and the latent width dimension W′ being some same or different fraction of the pixel width dimension W. Latent diffusion models can be preferable over standard diffusion models as they may utilize less memory resources, less computational resources, etc.

After training, the resulting iterative denoising process learned by the video diffusion model involves iteratively applying a sequence of noise samples to the trained model. The sequence of noise samples is generated based on an initial noise seed and a noise schedule that specifies how the noise properties are to vary from iteration to iteration. For example, each noise sample may have dimensions H×W×F for video diffusion models that operate in pixel space, or may have dimensions H′×W′×F for video diffusion models that operate in latent space. At each diffusion iteration, the trained video diffusion model attempts to denoise the noise samples to infer, or recover, a synthetic output video that satisfies one or more inputs applied to the model that specify the conditions, constraints, characteristics, etc., of the synthetic output video. For example, the model inputs may include a first (or starting) frame of the video, a last (or ending) frame of the video, an object mask that identifies (e.g., overlays) a region of the first frame corresponding to an object to be manipulated (e.g., moved) in the video, and a text string specifying how the object is to be manipulated. After the trained video diffusion model completes a total number of diffusion iterations T, the model outputs the generated synthetic output video.

Analysis of the synthetic videos output by video diffusion models has revealed that video quality can be influenced by the choice of the noise seed used to initialize noise sample generation. Examples disclosed herein implement attention-based noise seed selection, also referred to as Attention Consensus for Early Seed (ACE-Seed) selection, to select initial noise seeds for video diffusion models. As disclosed in further detail below, example ACE-seed selection techniques utilize attention data obtained during initial inference by the video diffusion model to analyze a set of candidate noise seeds and select one of the noise seeds that is likely to achieve acceptable video quality, such as motion fidelity, video generation stability, etc. Furthermore, example ACE-seed selection techniques disclosed herein are able to achieve such attention-based noise seed selection with nominal (e.g., low-level, minimal, etc.) computation overhead, without model retraining and without the use of auxiliary models. Moreover, example ACE-seed selection techniques disclosed herein are able to display interpretable attention maps associated with different ones of the candidate noise seeds, which can support noise seed inspection and selection by a user.

For example, ACE-seed selection techniques disclosed herein may generate a set of candidate noise seeds and then perform respective executions of the trained video diffusion model after initialization of the model with the corresponding noise seeds. In some examples, for each candidate noise seed, the ACE-seed selection technique causes the trained video diffusion model to perform a number of initial diffusion iterations after which the ACE-seed selection technique extracts a set of one or more attention maps from a corresponding one or more attention layers of the model. To reduce computational overhead, the number of initial diffusion iterations t may be less than, or even substantially less than, the total number of diffusion iterations T performed for synthetic video generation. For example, T may be 50 or more total iterations for video generation, whereas t may be 10 or fewer initial iterations for attention map extraction.

The example ACE-seed selection techniques then compute scores, such as similarity scores, difference scores, etc., for each of the candidate noise seeds based on the attention maps. The score for a given candidate noise seed represents how similar that candidate noise seed's attention map set is to the attention map sets for the other candidate noise seeds. In some examples, the ACE-seed selection techniques utilize the scores to select the candidate noise seed whose attention map set is most similar to the attention map sets for the other candidate noise seeds. In this way, the ACE-seed selection techniques select a noise seed that results in generated noise that shares similar attention characteristics with a variety of possible noise seeds, thereby helping to ensure synthetic video generation that achieves sufficient motion fidelity and stability to accurately reflect the model inputs.

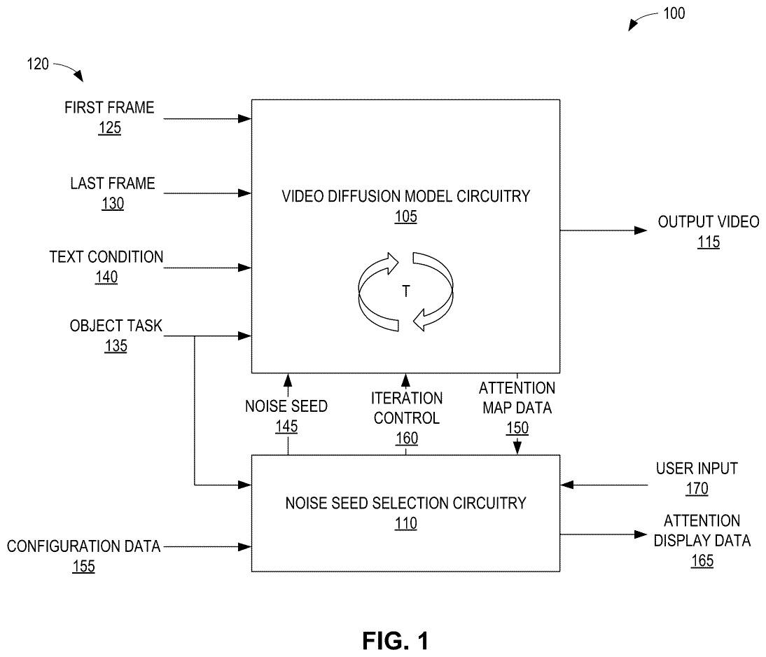

Turning to the figures, FIG. 1 is a block diagram of an example video generation system 100 that supports attention-based noise selection for video diffusion modeling in accordance with teachings of this disclosure. The example video generation system 100 of FIG. 1 may be instantiated (e.g., creating an instance of, bring into being for any length of time, materialize, implement, etc.) by programmable circuitry. For example, programmable circuitry may be implemented by a Central Processor Unit (CPU) executing first instructions, a field programmable gate array, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc. Additionally or alternatively, the example video generation system 100 of FIG. 1 may be instantiated (e.g., creating an instance of, bring into being for any length of time, materialize, implement, etc.) by (i) an Application Specific Integrated Circuit (ASIC) and/or (ii) a Field Programmable Gate Array (FPGA) (e.g., another form of programmable circuitry) structured and/or configured in response to execution of second instructions to perform operations corresponding to the first instructions. It should be understood that some or all of the circuitry of FIG. 1 may, thus, be instantiated at the same or different times. Some or all of the circuitry of FIG. 1 may be instantiated, for example, in one or more threads executing concurrently on hardware and/or in series on hardware. Moreover, in some examples, some or all of the circuitry of FIG. 1 may be implemented by microprocessor circuitry executing instructions and/or FPGA circuitry performing operations to implement one or more virtual machines and/or containers.

The video generation system 100 of the illustrated example includes example video diffusion model circuitry 105 and example noise seed selection circuitry 110. The video diffusion model circuitry 105 implements any trained video diffusional model capable of generating an example output video sequence 115, also referred to as an example output video 115, an example synthetic output video 115, etc., based on one or more example model inputs 120. In the illustrated example, the synthetic output video 115 from the video diffusion model circuitry 105 has a frame resolution of H height pixels by W width pixels and includes F total frames. As described above, in some examples, the video diffusional model implemented by the video diffusion model circuitry 105 may operate in pixel space and processes noise data having the same dimensions H×W×F as the synthetic output video 115, which corresponds to F noise frames having a resolution of H×W noise samples. However, in some examples, the video diffusional model implemented by the video diffusion model circuitry 105 may be an example latent video diffusional model that operates in latent space and processes noise data having the same reduced latent dimensionality. For example, an example latent video diffusion model implemented by the video diffusion model circuitry 105 may be trained to operate on noise data having dimensions H′×W′×F, corresponding to F noise frames having a reduced resolution of H′×W′ noise samples, with the latent height dimension H′ being some fraction of the pixel height dimension H, and the latent width dimension W′ being some same or different fraction of the pixel width dimension W.

The model inputs 120 of the illustrated example include an example first (or starting) frame 125 of the synthetic output video 115 to be generated, an example last (or ending) frame 130 of the synthetic output video 115 to be generated, an example object mask 135 that identifies (e.g., overlays) a region of the first frame 125 corresponding to an object to be manipulated (e.g., moved) in the synthetic output video 115, and an example text string 140 specifying how the object is to be manipulated in the synthetic output video 115. However, in some examples, the model inputs 120 may differ from those shown in the illustrated example of FIG. 1. For example, in some implementations of the video diffusion model circuitry 105, the model inputs may include the first (or starting) frame 125, the example object mask 135 and the example text string 140, but omit the last (or ending) frame 130. In some example implementations of the video diffusion model circuitry 105, the model inputs 120 may include the last (or ending) frame 130, the example object mask 135 and the example text string 140, but omit the first (or starting) frame 125.

As described above, the video diffusion model implemented by the video diffusion model circuitry 105 is trained to perform an iterative denoising process that involves performing a sequence of diffusion iterations on a corresponding sequence of noise samples iteratively applied to the video diffusion model to infer, or recover, a synthetic output video 115 that satisfies the model inputs 120. In the illustrated example, the video diffusion model circuitry 105 generates the sequence of noise samples based on an example initial noise seed 145 and a noise schedule that specifies how the noise properties are to vary from iteration to iteration. For example, each noise sample may have dimensions H×W×F for video diffusion models that operate in pixel space, or may have reduced dimensions H′×W′×F for video diffusion models that operate in latent space. At each diffusion iteration, the trained video diffusion model attempts to denoise a combination of the denoised sample from the previous iteration and a new noise sample applied at that current iteration to infer, or generate, the synthetic output video 115. After the video diffusion model circuitry 105 iterates the video diffusion model for a total number of diffusion iterations T, the video diffusion model circuitry 105 outputs the generated synthetic output video 115.

As described above, the choice of the noise seed 145 used to initialize noise sample generation can influence the quality of the synthetic output video 115 generated by the video diffusion model circuitry 105. Thus, the video generation system 100 includes the noise seed selection circuitry 110 to select an initial noise seed 145 for the video diffusion model circuitry 105 with a goal of achieving motion fidelity, video generation stability, etc., or otherwise producing acceptable video quality. The noise seed selection circuitry 110 of the illustrated example implements attention-based noise seed selection, also referred to as ACE-Seed selection, to select an initial noise seed for the video diffusion model circuitry 105. In the illustrated example, the noise seed selection circuitry 110 utilizes example attention map data 150 obtained during execution of the video diffusion model by the video diffusion model circuitry 105 to analyze a set of candidate noise seeds and select one of the candidate noise seeds to be used to initialize the video diffusion model circuitry 105 for synthesizing the output video 115. As such, the noise seed selection circuitry 110 of the illustrated example can be used with any video diffusion model that includes one or more attention layers capable of providing attention map data.

For example, the video diffusion model implemented by the video diffusion model circuitry 105 may include one or more attention layers, such as one or more self-attention layers, one or more multi-headed attention layers, etc. Such attention layers enable the video diffusion model to focus processing on relevant portions of the input noise frames and iteratively denoised frames when performing denoising to generate the synthetic output video sequence 115. In some examples, an attention layer converts the data at the input to the layer to key, query and value tensors, and then computes attention scores based on those tensors. The resulting attention scores form an attention map that can be resized to the resolution of a video frame, and the values in the attention map can represent how relevant given portions (e.g., pixels) of the frame are to the denoising process at that point in the video diffusion model.

In the illustrated example, the noise seed selection circuitry 110 generates a set of candidate noise seeds and then causes the video diffusion model circuitry 105 to perform respective executions of the trained video diffusion model after initialization of the model with the corresponding noise seeds. In some examples, for each candidate noise seed, the noise seed selection circuitry 110 causes the video diffusion model circuitry 105 to perform a number of initial diffusion iterations of the trained video diffusion model, after which the noise seed selection circuitry 110 extracts or otherwise obtains a set of one or more attention maps 150 from a corresponding one or more attention layers of the model. To reduce computational overhead, the noise seed selection circuitry 110 may specify the number of initial diffusion iterations t to be less than, or even substantially less than, the total number of diffusion iterations T performed by the video diffusion model circuitry 105 for synthetic video generation. For example, T may be 50 or more total iterations for video generation, whereas t may be 10 or fewer initial iterations for attention map extraction.

As such, the noise seed selection circuitry 110 of the illustrated example includes an example input to accept or otherwise obtain example configuration data 155 to configure ACE-seed selection. For example, the configuration data 155 may specify (i) the number of candidate noise seeds N to be generated for evaluation, (ii) the number of initial diffusion iterations t to be executed by the video diffusion model to generate the attention map data 150, and (iii) the total number of diffusion iterations T to be executed by the video diffusion model to generate the output video 115. In some examples, the configuration data 155 may specify which attention layer or layers of the video diffusion model are to be used to extract the attention map data 150.

In addition to the input for the configuration data 155, the noise seed selection circuitry 110 also includes an example output to specify the noise seed 145 to be used by the video diffusion model circuitry 105 to generate the noise samples for video diffusion processing. In some examples, during ACE-seed selection, the noise seed selection circuitry 110 provides the candidate noise seeds to the video diffusion model circuitry 105 via the noise seed output 145. However, after a candidate noise seed is selected, the noise seed selection circuitry 110 provides the selected noise seed to the video diffusion model circuitry 105 via the noise seed output 145. The noise seed selection circuitry 110 also includes an example output to provide example iteration control data 160 specifying a number of diffusion iterations to be executed or otherwise performed by the video diffusion model circuitry 105. For example, during ACE-seed selection, the noise seed selection circuitry 110 may set the iteration control data 160 to configure a relatively small number of initial diffusion model iterations t to be executed by the video diffusion model circuitry 105 to generate the attention map data 150. Then, after a candidate noise seed is selected, the noise seed selection circuitry 110 may set the iteration control data 160 to configure a total number of diffusion model iterations T to be executed by the video diffusion model circuitry 105 to generate the output video 115 based on the selected noise seed 145. The noise seed selection circuitry 110 further includes an example input to accept, extract or otherwise obtain the attention map data 150 from the one or more attention layers of the video diffusion model implemented by the video diffusion model circuitry 105.

As described above and in further detail below, the noise seed selection circuitry 110 of the illustrated example computes scores, such as similarity scores, difference scores, etc., for each of the candidate noise seeds based on the attention map data 150. In some examples, the score for a given candidate noise seed represents how similar that candidate noise seed's attention map set is to the attention map sets for the other candidate noise seeds. In some examples, the noise seed selection circuitry 110 utilizes the scores to select the candidate noise seed whose attention map set is most similar to the attention map sets for the other candidate noise seeds. In this way, the noise seed selection circuitry 110 selects a noise seed that results in generated noise that shares similar attention characteristics with a variety of possible noise seeds, thereby helping to ensure synthetic video generation that achieves sufficient motion fidelity and stability to accurately reflect the model inputs 120.

In some examples, the noise seed selection circuitry 110 generates example attention display data 165 that can be output to a display device to enable interpretable attention maps associated with different ones of the candidate noise seeds to be displayed to a user. As described above and in further detail below, an attention map set for a given candidate noise seed includes one or more attention maps extracted from one or more attention layers of the video diffusion model implemented by the video diffusion model circuitry 105. In some examples, the noise seed selection circuitry 110 combines the attention maps in the attention map set for a given candidate noise seed by computing the group average/mean, median, mode, etc., of the attention maps to determine a combined attention map for the given candidate noise seed. In some examples, the noise seed selection circuitry 110 converts the values in the combined attention map for the given candidate noise seed (or the single attention map for the given candidate noise seed if there is one map in the candidate seed's attention map set) to color values to generate the attention display data 165 for the given candidate noise seed as a heat map or similar graphical representation of the attention map data. The noise seed selection circuitry 110 may then output the attention display data 165 for display in a graphical user interface (GUI) and/or some other display format.

In some examples, the noise seed selection circuitry 110 outputs respective attention display data 165 (e.g., respective attention heat maps) for all of the candidate noise seeds. In some examples, the noise seed selection circuitry 110 outputs respective attention display data 165 (e.g., respective attention heat maps) for a subset of the candidate noise seeds selected based on their respective scores. For example, the noise seed selection circuitry 110 may output respective attention display data 165 (e.g., respective attention heat maps) for the c candidate noise seeds having the largest similarity scores (e.g., with c=2, 3, 4, etc.). The presentation of the attention display data 165 (e.g., respective attention heat maps) for the candidate noise seeds in a GUI or other display format supports noise seed inspection and selection by the user. As such, in some examples, the noise seed selection circuitry 110 includes an example input to accept example user input data 170 in the form of a user selection of one of the candidate noise seeds to be used for generating the synthetic output video 115.

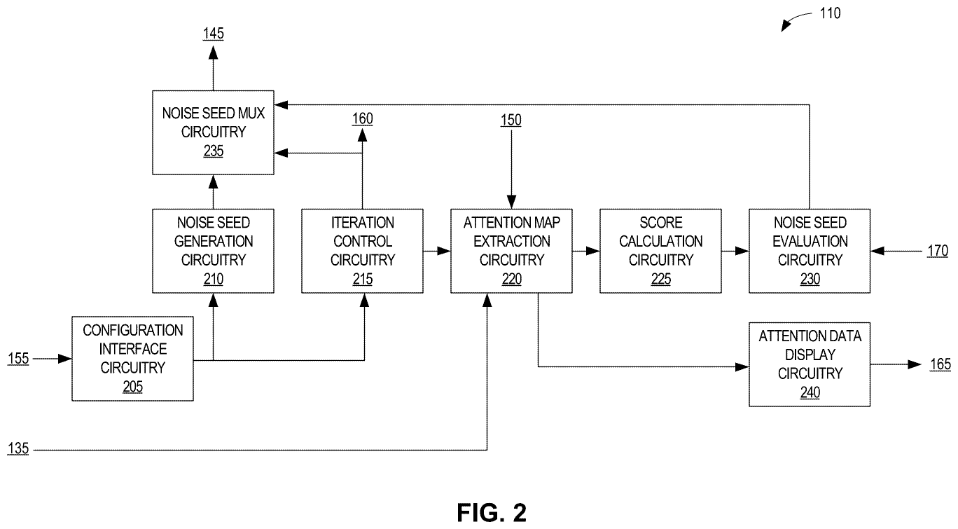

FIG. 2 is a block diagram of an example implementation of the noise seed selection circuitry 110 of FIG. 1. The example noise seed selection circuitry 110 of FIG. 2 may be instantiated (e.g., creating an instance of, bring into being for any length of time, materialize, implement, etc.) by programmable circuitry. For example, programmable circuitry may be implemented by a Central Processor Unit (CPU) executing first instructions, a field programmable gate array, a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc. Additionally or alternatively, the example noise seed selection circuitry 110 of FIG. 2 may be instantiated (e.g., creating an instance of, bring into being for any length of time, materialize, implement, etc.) by (i) an Application Specific Integrated Circuit (ASIC) and/or (ii) a Field Programmable Gate Array (FPGA) (e.g., another form of programmable circuitry) structured and/or configured in response to execution of second instructions to perform operations corresponding to the first instructions. It should be understood that some or all of the circuitry of FIG. 2 may, thus, be instantiated at the same or different times. Some or all of the circuitry of FIG. 2 may be instantiated, for example, in one or more threads executing concurrently on hardware and/or in series on hardware. Moreover, in some examples, some or all of the circuitry of FIG. 2 may be implemented by microprocessor circuitry executing instructions and/or FPGA circuitry performing operations to implement one or more virtual machines and/or containers.

The example noise seed selection circuitry 110 of FIG. 2 includes example configuration interface circuitry 205, example noise seed generation circuitry 210, example iteration control circuitry 215, example attention map extraction circuitry 220, example score calculation circuitry 225, example noise seed evaluation circuitry 230, example noise seed multiplexer (mux) circuitry 235 and example attention data display circuitry 240. The configuration interface circuitry 205 of the illustrated example accepts or otherwise obtains configuration data 155 to configure one or more parameters of the attention-based noise seed selection (e.g., ACE-seed selection) procedure implemented by the noise seed selection circuitry 110. For example, the configuration interface circuitry 205 may be implemented by one or more registers, pins, memory-mapped regions, data structures, etc., that can be programmed with the configuration data 155. In some examples, the configuration data 155 obtained via the configuration interface circuitry 205 includes one or more of (i) the number of candidate noise seeds N to be generated for evaluation, (ii) the number of initial diffusion iterations t to be executed by the video diffusion model to generate the attention map data 150, (iii) identification of the attention layer or layers of the video diffusion model to be used to extract the attention map data 150, (iv) the total number of diffusion iterations T to be executed by the video diffusion model to generate the output video 115, etc.

The noise seed generation circuitry 210 of the illustrated example generates a set of candidate noise seeds to be evaluated by the noise seed selection circuitry 110. For example, the noise seed generation circuitry 210 may implement any appropriate random number generator and/or pseudo-random number generator to generate a set of candidate noise seeds including a number of candidate noise seeds N corresponding to the number specified in the configuration data 155. In some examples, the noise seed generation circuitry 210 may format the generated candidate noise seeds to have a numerical format and range expected by the video diffusion model circuitry 105.

The iteration control circuitry 215 of the illustrated example sets the iteration control data 160 to configure the number of diffusion iterations to be performed by the video diffusion model implemented by the video diffusion model circuitry 105 for a given noise seed 145 applied to the model. For example, during evaluation of the set of candidate noise seeds for ACE-seed selection, the iteration control circuitry 215 may sets the iteration control data 160 to configure the video diffusion model circuitry 105 to evolve the video diffusion model for a number of initial diffusion iterations t that is less than, or even substantially less than, the total number of diffusion iterations T performed by the video diffusion model circuitry 105 for synthetic video generation. For example, for each candidate noise seed

$${x}_{0}^{( i )} ,$$

with i=1, . . . , N, the iteration control circuitry 215 may cause the video diffusion model circuitry 105 to evolve the video diffusion model for t 10 initial diffusion iterations, which is less than the total number of diffusion iterations T=50 performed by the video diffusion model circuitry 105 for synthetic video generation. After selection of the particular noise seed

$${x}_{0}^{( k )}$$

for final video signal generation, the iteration control circuitry 215 may then set the iteration control data 160 to configure the video diffusion model circuitry 105 to evolve the video diffusion model with the initial noise seed

$${x}_{0}^{( k )}$$

for the total number of diffusion iterations T to generate the synthetic output video 115.

The attention map extraction circuitry 220 of the illustrated example extracts, for each candidate noise seed

$${x}_{0}^{( i )} ,$$

with i=1, . . . , N, a set of one or more attention maps 150 from a corresponding one or more attention layers of the video diffusion model implemented by the video diffusion model circuitry 105. In the illustrated examples, the attention map extraction circuitry 220 extracts the set of one or more attention maps 150 for a given candidate noise seed

$${x}_{0}^{( i )}$$

after completion of the number of initial diffusion iterations t configured by the iteration control circuitry 215. In some examples, the attention map extraction circuitry 220 uses the inverse of the object mask 135 included in the model input data 120 to determine a token region of other portion of the attention layer data from which the attention maps at each respective layer is extracted. Use of the inverse of the object mask 135 enables the attention map extraction circuitry 220 to extract the attention map set 150 for a given candidate noise seed

$${x}_{0}^{( i )}$$

based on background information that is relatively consistent across video frames, as well as shape information associated with the foreground object being manipulated in the generated video. However, in some examples, the attention map extraction circuitry 220 implements any appropriate image segmentation procedure to determine a background mask to be used to extract the attention map set 150 for a given candidate noise seed

$${x}_{0}^{( i )} .$$

The resulting attention map set 150 extracted by the attention map extraction circuitry 220 can be represented mathematically according to Equation 1:

$${A}^{( i )} = \{ {A}_{l}^{( i )} , … {A}_{m}^{( i )} \} \qquad Equation 1$$

In Equation 1, the variables l, m denote the range of model attention layers from which the attention map(s) A are extracted for a given candidate noise seed

$${x}_{0}^{( i )} .$$

The score calculation circuitry 225 of the illustrated example computes scores s⁽ⁱ⁾, such as similarity scores, difference scores, etc., for each of the candidate noise seeds

$${x}_{0}^{( i )} ,$$

with i=1, . . . , N, based on the attention map data 150. In some examples, the score s⁽ⁱ⁾ for a given candidate noise seed

$${x}_{0}^{( i )}$$

is a similarity score that represents how similar that candidate noise seed's attention map set A⁽ⁱ⁾ is to the attention map sets for the other candidate noise seeds. In some examples, the score s⁽ⁱ⁾ for a given candidate noise seed

$${x}_{0}^{( i )}$$

is a difference score that represents how different that candidate noise seed's attention map set A⁽ⁱ⁾ is from the attention map sets for the other candidate noise seeds.

In some examples, to compute the score s⁽ⁱ⁾ for a given candidate noise seed

$${x}_{0}^{( i )} ,$$

the score calculation circuitry 225 combines the attention maps in the attention map set A⁽ⁱ⁾ for the given candidate noise seed

$${x}_{0}^{( i )}$$

by computing the group average/mean, median, mode, etc., of the attention maps

$${A}_{l}^{( i )} , … , {A}_{m}^{( i )}$$

to determine a combined attention map AC⁽ⁱ⁾ for the given candidate noise seed

$${x}_{0}^{( i )} .$$

In some examples, if the attention map set A⁽ⁱ⁾ for the given candidate noise seed

$${x}_{0}^{( i )}$$

includes just one attention map, the score calculation circuitry 225 sets the combined attention map AC⁽ⁱ⁾ for the given candidate noise seed

$${x}_{0}^{( i )}$$

equal to that one attention map.

In some examples, the score calculation circuitry 225 next computes pair-wise distances d_{i,j} among pairs of the combined attention maps (AC⁽ⁱ⁾, AC^{(j)}) across the different possible pairwise combinations of the candidate noise seed

$$( {x}_{0}^{( i )} , {x}_{0}^{( j )} ) ,$$

with i=1, . . . , N and j=1, . . . , N. The score calculation circuitry 225 can use any distance metric, such as an L1 norm, an L2 norm, a mean squared error, etc., to compute the pair-wise distances d_{i,j}. In some examples, the score calculation circuitry 225 arranges the pair-wise distances d_{i,j} in an N×N matrix. In some examples, the score calculation circuitry 225 computes the score s⁽ⁱ⁾ for a given candidate noise seed

$${x}_{0}^{( i )}$$

as an attention difference score by combining the pair-wise distances d_{i,j} involving the given candidate noise seed

$${x}_{0}^{( i )} .$$

For example, the score calculation circuitry 225 may compute the average/mean, median, mode, etc., of the pair-wise distances d_{i,j} involving the given candidate noise seed

$${x}_{0}^{( i )}$$

to determine the score s⁽ⁱ⁾ for the given candidate noise seed

$${x}_{0}^{( i )} .$$

In some examples, to reduce the computation load associated with score computation, the score calculation circuitry 225 computes the score s⁽ⁱ⁾ for a given candidate noise seed

$${x}_{0}^{( i )}$$

as an average distance d_avg_{i,j} between the combined attention map for the given candidate noise seed

$${x}_{0}^{( i )} ,$$

e.g., AC⁽ⁱ⁾, and a group average, or mean, of the combined attention maps for the other candidate noise seeds

$${x}_{0}^{( j )} ,$$

with j≠i. For example, the group average, or mean, of the combined attention maps for the other candidate noise seeds

$${x}_{0}^{( j )} ,$$

with j≠i, can be computed mathematically according to Equation 2:

$${ACmean}^{j \neq i} = \frac{1}{N - 1} {\sum }_{{j = 1}_{j \neq i}}^{N} A {C}^{( j )} \qquad Equation 2$$

The score calculation circuitry 225 can use any distance metric, such as an L1 norm, an L2 norm, a mean squared error, etc., to compute the average distance d_avg_{i,j} between the combined attention map for the given candidate noise seed

$${x}_{0}^{( i )} ,$$

e.g., AC⁽ⁱ⁾, and the average, or mean, of the combined attention maps for the other candidate noise seeds, ACmean^{j≠i}. The score calculation circuitry 225 then sets the score s⁽ⁱ⁾ for the given candidate noise seed

$${x}_{0}^{( i )}$$

equal to the average distance d_avg_{i,j} computed for that candidate noise seed

$${x}_{0}^{( i )} .$$

In some examples, the score calculation circuitry 225 next computes pair-wise similarities sim_{i,j} among pairs of the combined attention maps (AC⁽ⁱ⁾, AC^{(j)}) across the different possible pairwise combinations of the candidate noise seeds

$$( {x}_{0}^{( i )} , {x}_{0}^{( j )} ) ,$$

with i=1, . . . , N and j=1, . . . , N. The score calculation circuitry 225 can use any similarity metric, such as a cosine similarity, and/or an inverse of a difference metric, such as an L1 norm, an L2 norm, a mean squared error, etc., to compute the pair-wise similarities sim_{i,j}. In some examples, the score calculation circuitry 225 arranges the pair-wise similarities sim_{i,j} in an N× N matrix. In some examples, the score calculation circuitry 225 computes the score s⁽ⁱ⁾ for a given candidate noise seed

$${x}_{0}^{( i )}$$

as an attention similarity score by combining the pair-wise similarities sim_{i,j} involving the given candidate noise seed

$${x}_{0}^{( i )} .$$

For example, the score calculation circuitry 225 may compute the average/mean, median, mode, etc., of the pair-wise similarities sim_{i,j} involving the given candidate noise seed

$${x}_{0}^{( i )}$$

to determine the score s⁽ⁱ⁾ for the given candidate noise seed

$${x}_{0}^{( i )} .$$

In some examples, to reduce the computation load associated with score computation, the score calculation circuitry 225 computes the score s⁽ⁱ⁾ for a given candidate noise seed

$${x}_{0}^{( i )}$$

as an average similarity sim_avg_{i,j} between the combined attention map for the given candidate noise seed

$${x}_{0}^{( i )} ,$$

e.g., AC⁽ⁱ⁾, and an average, or mean, of the combined attention maps for the other candidate noise seeds

$${x}_{0}^{( j )} ,$$

with j≠i. For example, the average, or mean, of the combined attention maps for the other candidate noise seeds

$${x}_{0}^{( j )} ,$$

with j≠i, can be computed mathematically as ACmean^{j≠i} according to Equation 2 above. The score calculation circuitry 225 can use any similarity metric, such as a cosine similarity, and/or an inverse of a difference metric, such as an L1 norm, an L2 norm, a mean squared error, etc., to compute the average similarity sim_avg_{i,j} between the combined attention map for the given candidate noise seed

$${x}_{0}^{( i )} ,$$

e.g., AC⁽ⁱ⁾, and the average, or mean, of the combined attention maps for the other candidate noise seeds, ACmean^{j≠i}. The score calculation circuitry 225 then sets the score s⁽ⁱ⁾ for the given candidate noise seed

$${x}_{0}^{( i )}$$

equal to the average similarity sim_avg_{i,j} computed for that candidate noise seed

$${x}_{0}^{( i )} .$$

The noise seed evaluation circuitry 230 of the illustrated example selects one of the candidate noise seeds

$${x}_{0}^{( i )} ,$$

i=1, . . . , N, to be the initial noise seed

$${x}_{0}^{( k )}$$

for synthetic video generation. In the illustrated examples, the noise seed evaluation circuitry 230 selects the initial noise seed

$${x}_{0}^{( k )}$$

based on the score s⁽ⁱ⁾ computed by the score calculation circuitry 225 for the given candidate noise seeds

$${x}_{0}^{( i )} ,$$

i=1, . . . , N. For example, the noise seed evaluation circuitry 230 may evaluate the score s⁽ⁱ⁾ to select the noise seed

$${x}_{0}^{( k )}$$

with the highest attention overlap with the other candidate noise seeds. In some examples, distance-based scores s⁽ⁱ⁾, the noise seed evaluation circuitry 230 may select the noise seed

$${x}_{0}^{( k )}$$

with the smallest (e.g., minimum) score s⁽ⁱ⁾ as the seed with highest attention overlap with the other candidate noise seeds. In some examples, for similarity-based scores s⁽ⁱ⁾, the noise seed evaluation circuitry 230 may select the noise seed

$${x}_{0}^{( k )}$$

with the largest (e.g., maximum) score s⁽ⁱ⁾ as the seed with highest attention overlap with the other candidate noise seeds. Intuitively, the selected seed's attention behavior represents the most stable or central solution among the candidates.

Table 1 includes an example pseudo-code implementation of the ACE-Seed selection algorithm implemented by the noise seed generation circuitry 210, the iteration control circuitry 215, the attention map extraction circuitry 220, the score calculation circuitry 225, and the noise seed evaluation circuitry 230, as described above.

TABLE 1
Algorithm 1 ACE-Seed: Attention Consensus for
Early-step Seed selection

```
Require: Number of seeds N, early steps t_{early}
Ensure: Selected seed index k
  for i = 1 to N do
    $Roll out seed {x}_{0}^{( i )} for {t}_{early} steps$
    Extract self-attention maps A⁽ⁱ⁾
  end for
  for i = 1 to N do
    Compute similarity score s⁽ⁱ⁾
  end for
  k ← arg maxᵢ s⁽ⁱ⁾
  return k
```

The noise seed mux circuitry 235 of the illustrated examples enables the iteration control circuitry 215 to select between providing the candidate noise seeds

$${x}_{0}^{( i )}$$

to the video diffusion model circuitry 105 during ACE-seed selection, or providing the selected noise seed

$${x}_{0}^{( k )}$$

to the video diffusion model circuitry 105 for generation of the synthetic output video 115.

In some examples, the noise seed selection circuitry 110 selects multiple (e.g., two or more) of the candidate noise seeds

$${x}_{0}^{( i )} ,$$

i=1, . . . , N, to be respective initial noise seeds

$${x}_{0}^{( k )}$$

for generation of corresponding multiple (e.g., two or more) synthetic output videos 115. For examples, the noise seed selection circuitry 110 may select the c candidate noise seeds

$${x}_{0}^{( i )}$$

having the largest similarity-based scores s⁽ⁱ⁾ or the smallest distance-based scores s⁽ⁱ⁾ (e.g., with c=2, 3, 4, etc.) to be the respective initial noise seeds

$${x}_{0}^{( k )}$$

for generation of corresponding multiple (e.g., two or more) synthetic output videos 115. In some such examples, the iteration control circuitry 215 uses the noise seed mux circuitry 235 to provide the selected multiple (e.g., two or more) initial noise seeds

$${x}_{0}^{( k )}$$

sequentially to the video diffusion model circuitry 105 for generation of respective multiple (e.g., two or more) synthetic output videos 115 corresponding respectively to the selected multiple (e.g., two or more) initial noise seeds

$${x}_{0}^{( k )} .$$

In some examples, the noise seed selection circuitry 110 of FIG. 2 includes the attention data display circuitry 240 to generate attention display data 165 that can be output to a display device to enable interpretable attention maps associated with different ones of the candidate noise seeds

$${x}_{0}^{( i )}$$

to be displayed to a user. In some examples, the attention data display circuitry 240 (or the score calculation circuitry 225, as described above) combines the attention maps in the attention map set A⁽ⁱ⁾ for a given candidate noise seed

$${x}_{0}^{( i )}$$

by computing the average/mean, median, mode, etc., of the attention maps to determine a combined attention map AC⁽ⁱ⁾ for the given candidate noise seed

$${x}_{0}^{( i )} .$$

In some examples, the attention data display circuitry 240 converts the values in the combined attention map AC⁽ⁱ⁾ for the given candidate noise seed

$${x}_{0}^{( i )}$$

(or the single attention map for the given candidate noise seed if there is one map in the candidate seed's attention map set A⁽ⁱ⁾) to color values (e.g., RGB pixel values, YUV pixel values, etc.) to generate the attention display data 165 for the given candidate noise seed

$${x}_{0}^{( i )}$$

as a heat map or similar graphical representation of the attention map data. The attention data display circuitry 240 may then output the attention display data 165 for display in a graphical user interface (GUI) and/or some other display format.

In some examples, the attention data display circuitry 240 outputs respective attention display data 165 (e.g., respective attention heat maps) for all of the candidate noise seeds

$${x}_{0}^{( i )} .$$

In some examples, the attention data display circuitry 240 outputs respective attention display data 165 (e.g., respective attention heat maps) for a subset of the candidate noise seeds

$${x}_{0}^{( i )}$$

selected based on their respective scores s⁽ⁱ⁾ computed by the score calculation circuitry 225. For example, the attention data display circuitry 240 may output respective attention display data 165 (e.g., respective attention heat maps) for the c candidate noise seeds

$${x}_{0}^{( i )}$$

having the largest similarity-based scores s⁽ⁱ⁾ or the smallest distance-based scores s⁽ⁱ⁾ (e.g., with c=2, 3, 4, etc.).

The presentation of the attention display data 165 (e.g., respective attention heat maps) for the candidate noise seeds

$${x}_{0}^{( i )}$$

in a GUI or other display format supports noise seed inspection and selection by the user. As such, in some examples, noise seed evaluation circuitry 230 includes an example input to accept example user input data 170 in the form of a user selection of one of the candidate noise seeds

$${x}_{0}^{( i )}$$

as the initial noise seed

$${x}_{0}^{( k )}$$

to be used for generating the synthetic output video 115. For example, the user input data 170 indicating the candidate seed selection

$${x}_{0}^{( k )}$$

may be generated by the GUI displaying the attention display data 165 to the user.

In some examples, the noise seed evaluation circuitry 230 can accept user input data 170 including a user selection of multiple (e.g., two or more) of the candidate noise seeds

$${x}_{0}^{( i )}$$

to be used as initial noise seeds

$${x}_{0}^{( k )}$$

for generating corresponding multiple (e.g., two or more) synthetic output videos 115 based on the respective selected noise seeds. In some such examples, the iteration control circuitry 215 uses the noise seed mux circuitry 235 to provide the selected multiple (e.g., two or more) initial noise seeds

$${x}_{0}^{( k )}$$

sequentially to the video diffusion model circuitry 105 for generation of respective multiple (e.g., two or more) synthetic output videos 115 corresponding respectively to the different user noise seed selections.

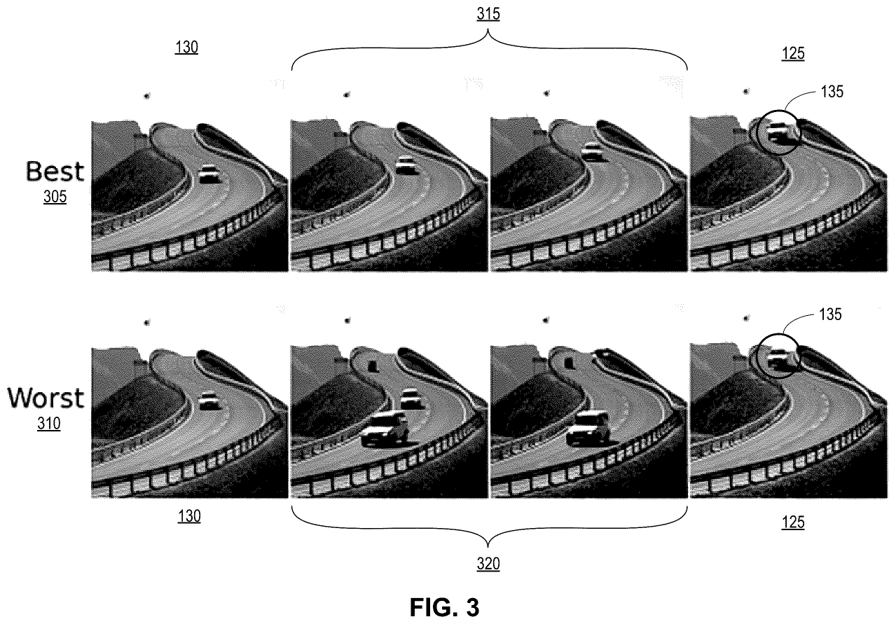

FIG. 3 illustrates example synthetic videos 305 and 310 generated by the example video diffusion model of FIG. 1 using different noise seeds selected by the example noise seed selection circuitry 110 of FIGS. 1 and/or 2. The synthetic videos 305 and 310 are both generated by the video diffusion model circuitry 105 executing a video diffusion model configured with the same first (or starting) frame 125, the same last (or ending) frame 130, the same object mask 135 identifying the object (e.g., automobile) to be manipulated in the video, and the same text string 140 specifying how the object is to be manipulated (e.g., “show the automobile driving along the road”). The synthetic videos 305 and 310 differ based on the different noise seeds used by the video diffusion model circuitry 105 to initialize the video diffusion model. In particular, the synthetic video 305 is based on the candidate noise seed have the best score s⁽ⁱ⁾ (e.g., the largest similarity-based score, the smallest difference-based score, etc.), whereas the synthetic video 310 is based on the candidate noise seed have the worst score s⁽ⁱ⁾ (e.g., the smallest similarity-based score, the largest difference-based score, etc.). As shown in the figures, the synthetic video 305 associated with the best candidate noise seed includes generated video frames 315 that achieve motion fidelity and stability that accurately reflect the model inputs. In contrast, the synthetic video 310 associated with the worst candidate noise seed includes generated video frames 320 that demonstrate motion instability (e.g., frames omitting the target automobile) and other artifacts (e.g., frames including additional vehicles) that do not accurately reflect the model inputs.

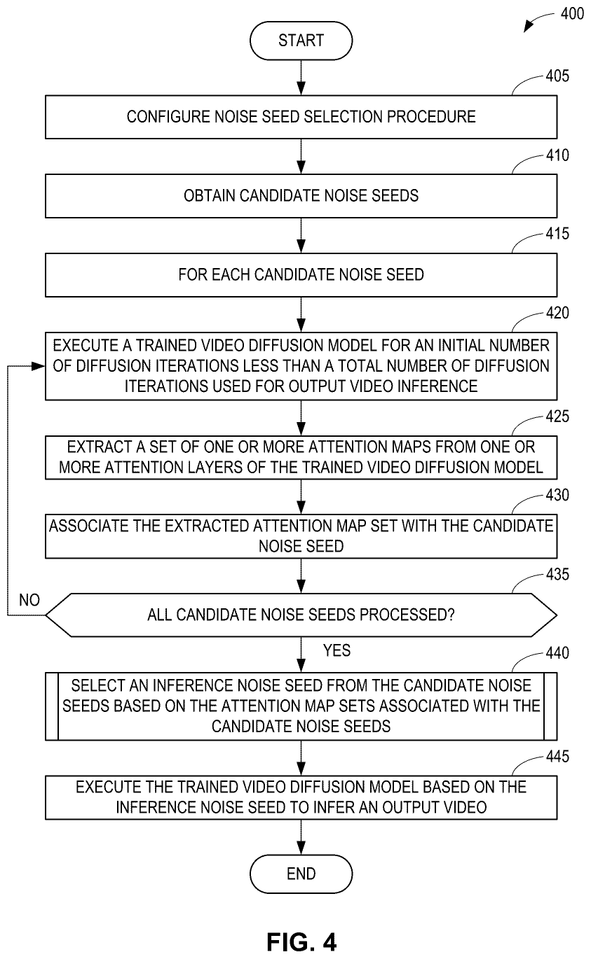

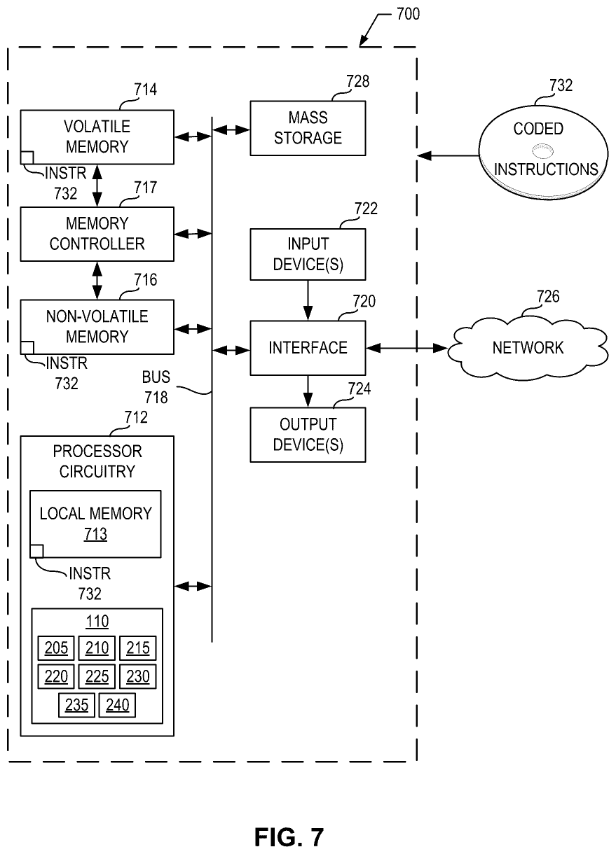

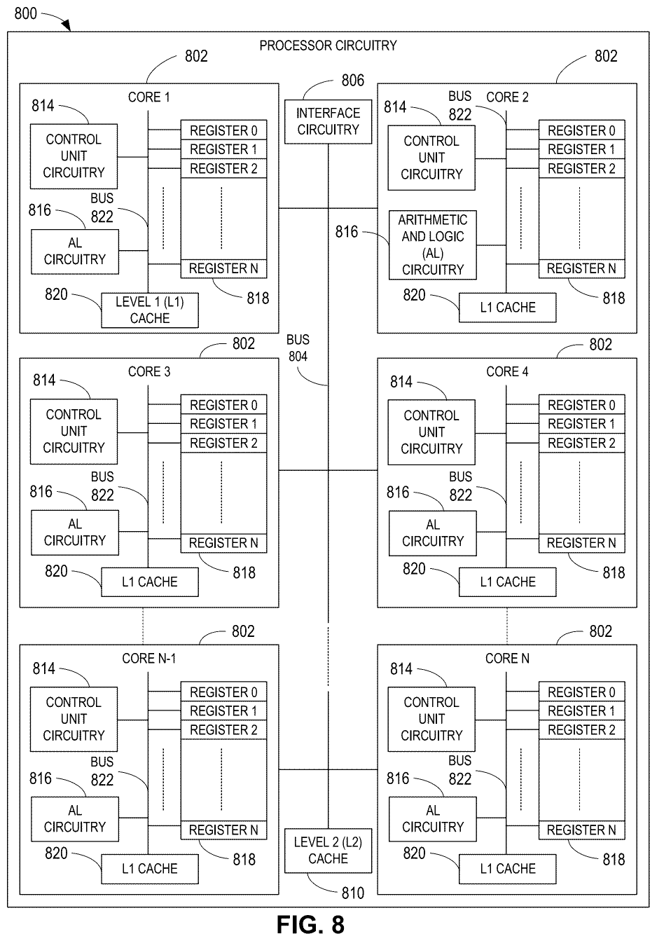

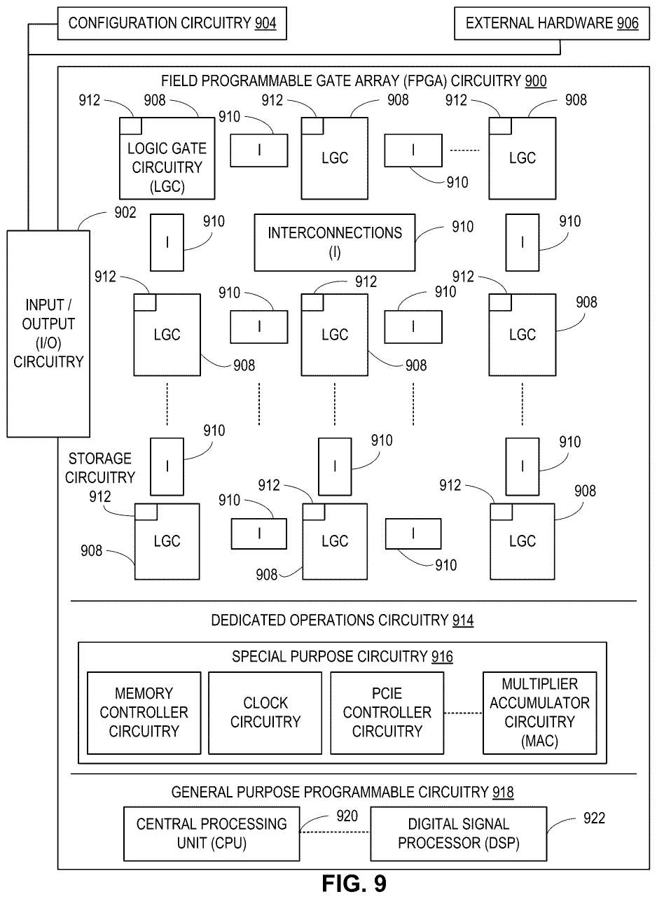

Based on the foregoing description, in some examples, the noise seed selection circuitry 110 includes means for obtaining configuration data. For example, the means for obtaining configuration data may be implemented by the configuration interface circuitry 205. In some examples, the configuration interface circuitry 205 may be instantiated by programmable circuitry such as the example programmable circuitry 712 of FIG. 7. For instance, the configuration interface circuitry 205 may be instantiated by the example microprocessor 800 of FIG. 8 executing machine executable instructions such as those implemented by at least block 405 of FIG. 4. In some examples, the configuration interface circuitry 205 may be instantiated by hardware logic circuitry, which may be implemented by an ASIC, XPU, or the FPGA circuitry 900 of FIG. 9 configured and/or structured to perform operations corresponding to the machine-readable instructions. Additionally or alternatively, the configuration interface circuitry 205 may be instantiated by any other combination of hardware, software, and/or firmware. For example, the configuration interface circuitry 205 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In some examples, the noise seed selection circuitry 110 includes means for generating noise seeds. For example, the means for generating noise seeds may be implemented by the noise seed generation circuitry 210. In some examples, the noise seed generation circuitry 210 may be instantiated by programmable circuitry such as the example programmable circuitry 712 of FIG. 7. For instance, the noise seed generation circuitry 210 may be instantiated by the example microprocessor 800 of FIG. 8 executing machine executable instructions such as those implemented by at least block 410 of FIG. 4. In some examples, the noise seed generation circuitry 210 may be instantiated by hardware logic circuitry, which may be implemented by an ASIC, XPU, or the FPGA circuitry 900 of FIG. 9 configured and/or structured to perform operations corresponding to the machine-readable instructions. Additionally or alternatively, the noise seed generation circuitry 210 may be instantiated by any other combination of hardware, software, and/or firmware. For example, the noise seed generation circuitry 210 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In some examples, the noise seed selection circuitry 110 includes means for iteration control. For example, the means for iteration control may be implemented by the iteration control circuitry 215. In some examples, the iteration control circuitry 215 may be instantiated by programmable circuitry such as the example programmable circuitry 712 of FIG. 7. For instance, the iteration control circuitry 215 may be instantiated by the example microprocessor 800 of FIG. 8 executing machine executable instructions such as those implemented by at least blocks 415, 420, 435 and 440 of FIG. 4. In some examples, the iteration control circuitry 215 may be instantiated by hardware logic circuitry, which may be implemented by an ASIC, XPU, or the FPGA circuitry 900 of FIG. 9 configured and/or structured to perform operations corresponding to the machine-readable instructions. Additionally or alternatively, the iteration control circuitry 215 may be instantiated by any other combination of hardware, software, and/or firmware. For example, the iteration control circuitry 215 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In some examples, the noise seed selection circuitry 110 includes means for extracting attention maps. For example, the means for extracting attention maps may be implemented by the attention map extraction circuitry 220. In some examples, the attention map extraction circuitry 220 may be instantiated by programmable circuitry such as the example programmable circuitry 712 of FIG. 7. For instance, the attention map extraction circuitry 220 may be instantiated by the example microprocessor 800 of FIG. 8 executing machine executable instructions such as those implemented by at least blocks 425 and 430 of FIG. 4. In some examples, the attention map extraction circuitry 220 may be instantiated by hardware logic circuitry, which may be implemented by an ASIC, XPU, or the FPGA circuitry 900 of FIG. 9 configured and/or structured to perform operations corresponding to the machine-readable instructions. Additionally or alternatively, the attention map extraction circuitry 220 may be instantiated by any other combination of hardware, software, and/or firmware. For example, the attention map extraction circuitry 220 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

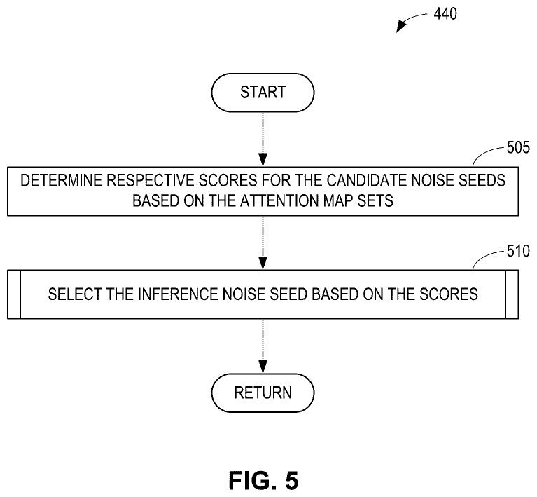

In some examples, the noise seed selection circuitry 110 includes means for calculating scores. For example, the means for calculating scores may be implemented by the score calculation circuitry 225. In some examples, the score calculation circuitry 225 may be instantiated by programmable circuitry such as the example programmable circuitry 712 of FIG. 7. For instance, the score calculation circuitry 225 may be instantiated by the example microprocessor 800 of FIG. 8 executing machine executable instructions such as those implemented by at least block 505 of FIG. 5. In some examples, the score calculation circuitry 225 may be instantiated by hardware logic circuitry, which may be implemented by an ASIC, XPU, or the FPGA circuitry 900 of FIG. 9 configured and/or structured to perform operations corresponding to the machine-readable instructions. Additionally or alternatively, the score calculation circuitry 225 may be instantiated by any other combination of hardware, software, and/or firmware. For example, the score calculation circuitry 225 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

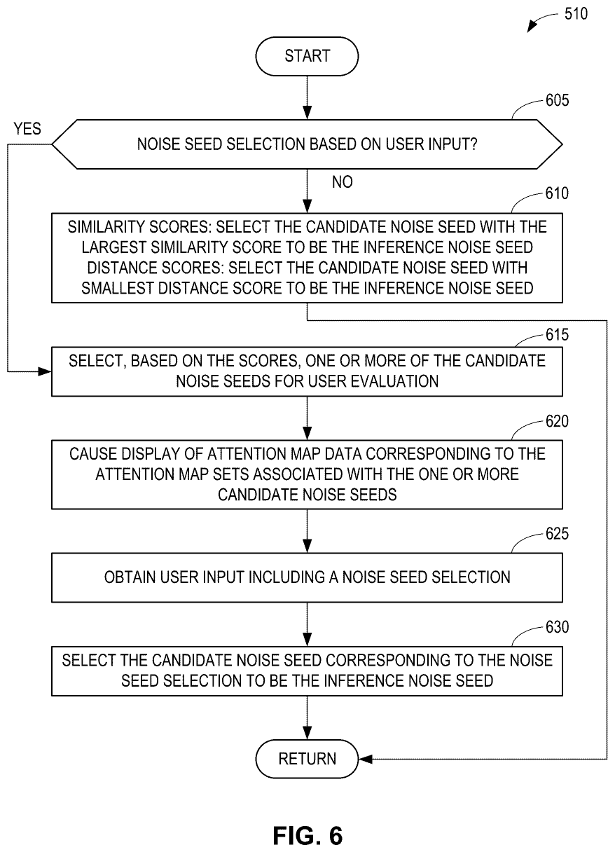

In some examples, the noise seed selection circuitry 110 includes means for evaluating noise seeds. For example, the means for evaluating noise seeds may be implemented by the noise seed evaluation circuitry 230. In some examples, the noise seed evaluation circuitry 230 may be instantiated by programmable circuitry such as the example programmable circuitry 712 of FIG. 7. For instance, the noise seed evaluation circuitry 230 may be instantiated by the example microprocessor 800 of FIG. 8 executing machine executable instructions such as those implemented by at least block 440 of FIG. 4, block 510 of FIG. 5 and/or blocks 605-630 of FIG. 6. In some examples, the noise seed evaluation circuitry 230 may be instantiated by hardware logic circuitry, which may be implemented by an ASIC, XPU, or the FPGA circuitry 900 of FIG. 9 configured and/or structured to perform operations corresponding to the machine-readable instructions. Additionally or alternatively, the noise seed evaluation circuitry 230 may be instantiated by any other combination of hardware, software, and/or firmware. For example, the noise seed evaluation circuitry 230 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In some examples, the noise seed selection circuitry 110 includes means for multiplexing noise seeds. For example, the means for multiplexing noise seeds may be implemented by the noise seed mux circuitry 235. In some examples, the noise seed mux circuitry 235 may be instantiated by programmable circuitry such as the example programmable circuitry 712 of FIG. 7. For instance, the noise seed mux circuitry 235 may be instantiated by the example microprocessor 800 of FIG. 8 executing machine executable instructions such as those implemented by at least blocks 420 and 445 of FIG. 4. In some examples, the noise seed mux circuitry 235 may be instantiated by hardware logic circuitry, which may be implemented by an ASIC, XPU, or the FPGA circuitry 900 of FIG. 9 configured and/or structured to perform operations corresponding to the machine-readable instructions. Additionally or alternatively, the noise seed mux circuitry 235 may be instantiated by any other combination of hardware, software, and/or firmware. For example, the noise seed mux circuitry 235 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

In some examples, the noise seed selection circuitry 110 includes means for displaying attention data. For example, the means for displaying attention data may be implemented by the attention data display circuitry 240. In some examples, the attention data display circuitry 240 may be instantiated by programmable circuitry such as the example programmable circuitry 712 of FIG. 7. For instance, the attention data display circuitry 240 may be instantiated by the example microprocessor 800 of FIG. 8 executing machine executable instructions such as those implemented by at least blocks 615 and 620 of FIG. 6. In some examples, the attention data display circuitry 240 may be instantiated by hardware logic circuitry, which may be implemented by an ASIC, XPU, or the FPGA circuitry 900 of FIG. 9 configured and/or structured to perform operations corresponding to the machine-readable instructions. Additionally or alternatively, the attention data display circuitry 240 may be instantiated by any other combination of hardware, software, and/or firmware. For example, the attention data display circuitry 240 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine-readable instructions and/or to perform some or all of the operations corresponding to the machine-readable instructions without executing software or firmware, but other structures are likewise appropriate.

While an example manner of implementing the noise seed selection circuitry 110 of FIG. 1 is illustrated in FIG. 2, one or more of the elements, processes, and/or devices illustrated in FIG. 2 may be combined, divided, re-arranged, omitted, eliminated, and/or implemented in any other way. Further, the example configuration interface circuitry 205, the example noise seed generation circuitry 210, the example iteration control circuitry 215, the example attention map extraction circuitry 220, the example score calculation circuitry 225, the example noise seed evaluation circuitry 230, the example noise seed multiplexer (mux) circuitry 235, the example attention data display circuitry 240, and/or, more generally, the example noise seed selection circuitry 110 of FIG. 2, may be implemented by hardware alone or by hardware in combination with software and/or firmware. Thus, for example, any of the example configuration interface circuitry 205, the example noise seed generation circuitry 210, the example iteration control circuitry 215, the example attention map extraction circuitry 220, the example score calculation circuitry 225, the example noise seed evaluation circuitry 230, the example noise seed multiplexer (mux) circuitry 235, the example attention data display circuitry 240, and/or, more generally, the example noise seed selection circuitry 110, could be implemented by programmable circuitry, processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), vision processing units (VPUs), and/or field programmable logic device(s) (FPLD(s)) such as FPGAs in combination with machine-readable instructions (e.g., firmware or software). Further still, the example noise seed selection circuitry 110 of FIG. 2 may include one or more elements, processes, and/or devices in addition to, or instead of, those illustrated in FIG. 2, and/or may include more than one of any or all of the illustrated elements, processes and devices.

Flowchart(s) representative of example machine-readable instructions, which may be executed by programmable circuitry to implement and/or instantiate the noise seed selection circuitry 110 of FIG. 2 and/or representative of example operations which may be performed by programmable circuitry to implement and/or instantiate the noise seed selection circuitry 110 of FIG. 2, are shown in FIGS. 4-6. The machine-readable instructions may be one or more executable programs or portion(s) of one or more executable programs for execution by programmable circuitry such as the programmable circuitry 712 shown in the example processor platform 700 discussed below in connection with FIG. 7 and/or may be one or more function(s) or portion(s) of functions to be performed by the example programmable circuitry (e.g., an FPGA) discussed below in connection with FIGS. 8 and/or 9. In some examples, the machine-readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer-readable and/or machine-readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer-readable and/or machine-readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine-readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer-readable storage medium may include one or more mediums. Further, although the example program is described with reference to the flowchart(s) illustrated in FIGS. 4-6, many other methods of implementing the example noise seed selection circuitry 110 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). As used herein, programmable circuitry includes any type(s) of circuitry that may be programmed to perform a desired function such as, for example, a CPU, a GPU, a VPU, and/or an FPGA. The programmable circuitry may include one or more CPUs, one or more GPUs, one or more VPUs, and/or one or more FPGAs located in the same package (e.g., the same integrated circuit (IC) package or in two or more separate housings), one or more CPUs, GPUs, VPUs, and/or one or more FPGAs in a single machine, multiple CPUs, GPUs, VPUs, and/or FPGAs distributed across multiple servers of a server rack, and/or multiple CPUs, GPUs, VPUs, and/or FPGAs distributed across one or more server racks. Additionally or alternatively, programmable circuitry may include a programmable logic device (PLD), a generic array logic (GAL) device, a programmable array logic (PAL) device, a complex programmable logic device (CPLD), a simple programmable logic device (SPLD), a microcontroller (MCU), a programmable system on chip (PSoC), etc., and/or any combination(s) thereof in any of the contexts explained above. As used herein, the term “circuitry” refers to at least one “circuit.” Thus, circuitry refers to a circuit or a system of circuits. As used herein, programmable circuitry includes and/or corresponds to at least one programmable circuit.

The machine-readable instructions described herein may be stored in one or more of a compressed format, an encrypted format, a fragmented format, a compiled format, an executable format, a packaged format, etc. Machine-readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine-readable instructions may be fragmented and stored on one or more storage devices, disks and/or computing devices (e.g., servers) located at the same or different locations of a network or collection of networks (e.g., in the cloud, in edge devices, etc.). The machine-readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine-readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine-readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine-readable instructions may need to be configured (e.g., settings stored, data input, network addresses recorded, etc.) before the machine-readable instructions and/or the corresponding program(s) can be executed in whole or in part. Thus, machine-readable, computer-readable and/or machine-readable media, as used herein, may include instructions and/or program(s) regardless of the particular format or state of the machine-readable instructions and/or program(s).

The machine-readable instructions described herein can be represented by any past, present, or future instruction language, scripting language, programming language, etc. For example, the machine-readable instructions may be represented using any of the following languages: C, C++, Java, C-Sharp, Perl, Python, JavaScript, HyperText Markup Language (HTML), Structured Query Language (SQL), Swift, etc.

As mentioned above, the example operations of FIGS. 4-6 may be implemented using executable instructions (e.g., computer-readable and/or machine-readable instructions) stored on one or more non-transitory computer-readable and/or machine-readable media. As used herein, the terms non-transitory computer-readable medium, non-transitory computer-readable storage medium, non-transitory machine-readable medium, and/or non-transitory machine-readable storage medium are expressly defined to include any type of computer-readable storage device and/or storage disk and to exclude propagating signals and to exclude transmission media. Examples of such non-transitory computer-readable medium, non-transitory computer-readable storage medium, non-transitory machine-readable medium, and/or non-transitory machine-readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer-readable storage device” and “non-transitory machine-readable storage device” are defined to include any physical (mechanical, magnetic and/or electrical) hardware to retain information for a time period, but to exclude propagating signals and to exclude transmission media. Examples of non-transitory computer-readable storage devices and/or non-transitory machine-readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer-readable instructions, machine-readable instructions, etc., and/or manufactured to execute computer-readable instructions, machine-readable instructions, etc.

FIG. 4 is a flowchart representative of example machine-readable instructions and/or example operations 400 that may be executed, instantiated, and/or performed by programmable circuitry to implement the noise seed selection circuitry 110 of FIGS. 1 and/or 2. The example machine-readable instructions and/or the example operations 400 of FIG. 4 begin at block 405, at which the configuration interface circuitry 205 of the noise seed selection circuitry 110 obtains the configuration data 155 to configure ACE-Seed noise seed selection procedure, as described above. At block 410, the noise seed generation circuitry 210 of the noise seed selection circuitry 110 obtains (e.g., generates) a set of candidate noise seeds based on the configuration data 155, as described above.

At block 415, the noise seed selection circuitry 110 begins iterating over the different candidate noise seeds. At block 420, the iteration control circuitry 215 of the noise seed selection circuitry 110 causes the video diffusion model circuitry 105 to execute a trained video diffusion model for an initial number of diffusion iterations t less than a total number of diffusion iterations T used for output video inference, as described above. At block 420, the iteration control circuitry 215 also provides the candidate noise seed corresponding to the current iteration to the video diffusion model circuitry 105 via the noise seed mux circuitry 235, as described above. At block 425, the attention map extraction circuitry 220 of the noise seed selection circuitry 110 extracts a set of one or more attention maps from one or more attention layers of the trained video diffusion model, as described above. At block 430, the attention map extraction circuitry 220 associates the extracted attention map set with the candidate noise seed corresponding to the current iteration, as described above. At block 435, the noise seed selection circuitry 110 continues iterating over the candidate noise seeds until all candidate noise seeds have been processed.

At block 440, the noise seed evaluation circuitry 230 of the noise seed selection circuitry 110 selects an inference noise seed from the candidate noise seeds based on the attention map sets associated with candidate noise seeds. For example, the noise seed evaluation circuitry 230 selects the inference noise seed based on scores determined by the score calculation circuitry 225 of the noise seed evaluation circuitry 230 based on the attention map sets associated with the candidate noise seeds, as described above. At block 445, the iteration control circuitry 215 of the noise seed selection circuitry 110 causes the video diffusion model circuitry 105 to execute the trained video diffusion model based on the inference noise seed for the total number of diffusion iterations T to infer an output video, as described above. At block 420, the iteration control circuitry 215 provides the inference noise seed to the video diffusion model circuitry 105 via the noise seed mux circuitry 235, as described above. The example machine-readable instructions and/or the example operations 400 of FIG. 4 then end.

FIG. 5 is a flowchart representative of example machine-readable instructions and/or example operations 440 that may be executed, instantiated, and/or performed by programmable circuitry to perform the processing at block 440 of FIG. 4. The example machine-readable instructions and/or the example operations 440 of FIG. 5 begin at block 505, at which the score calculation circuitry 225 of the noise seed selection circuitry 110 determines respective scores for the candidate noise seeds based on the attention map sets, as described above. At block 510, the noise seed evaluation circuitry 230 of the noise seed selection circuitry 110 selects the inference noise seed based on the scores, as described above. The example machine-readable instructions and/or the example operations 440 of FIG. 5 then end.

FIG. 6 is a flowchart representative of example machine-readable instructions and/or example operations 510 that may be executed, instantiated, and/or performed by programmable circuitry to perform the processing at block 510 of FIG. 5. The example machine-readable instructions and/or the example operations 510 of FIG. 6 begin at block 605, at which the noise seed evaluation circuitry 230 of the noise seed selection circuitry 110 determines whether noise seed selection is based on user input. If noise seed selection is not based on user input (corresponding to the NO output of block 605), at block 610, if the scores determined for the candidate noise seeds are similarity-based scores, the noise seed evaluation circuitry 230 selects the candidate noise seed with the largest similarity score to be the inference noise seed, as described above. However, if the scores determined for the candidate noise seeds are difference-based scores, the noise seed evaluation circuitry 230 selects the candidate noise seed with the smallest distance score to be the inference noise seed, as described above. The example machine-readable instructions and/or the example operations 510 of FIG. 6 then end.

However, if noise seed selection is based on user input (corresponding to the YES output of block 605), at block 615, the attention data display circuitry 240 of the noise seed selection circuitry 110 selects, based on the scores, one or more of the candidate noise seeds for user evaluation, as described above. At block 620, the attention data display circuitry 240 causes display of attention map data corresponding to the attention map sets associated with the one or more candidate noise seeds, as described above. At block 625, the noise seed evaluation circuitry 230 obtains user input including a noise seed selection, as described above. At block 630, the noise seed evaluation circuitry 230 selects the candidate noise seed corresponding to the noise seed selection to be the inference noise seed, as described above. The example machine-readable instructions and/or the example operations 510 of FIG. 6 then end.

FIG. 7 is a block diagram of an example programmable circuitry platform 700 structured to execute and/or instantiate the example machine-readable instructions and/or the example operations of FIGS. 4-6 to implement the noise seed selection circuitry 110 of FIG. 2. The programmable circuitry platform 700 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing and/or electronic device.

The programmable circuitry platform 700 of the illustrated example includes programmable circuitry 712. The programmable circuitry 712 of the illustrated example is hardware. For example, the programmable circuitry 712 can be implemented by one or more integrated circuits, logic circuits, FPGAs, microprocessors, CPUs, GPUs, VPUs, DSPs, and/or microcontrollers from any desired family or manufacturer. The programmable circuitry 712 may be implemented by one or more semiconductor based (e.g., silicon based) devices. In this example, the programmable circuitry 712 implements the example configuration interface circuitry 205, the example noise seed generation circuitry 210, the example iteration control circuitry 215, the example attention map extraction circuitry 220, the example score calculation circuitry 225, the example noise seed evaluation circuitry 230, the example noise seed multiplexer (mux) circuitry 235, the example attention data display circuitry 240 and/or, more generally, the noise seed selection circuitry 110.

The programmable circuitry 712 of the illustrated example includes a local memory 713 (e.g., a cache, registers, etc.). The programmable circuitry 712 of the illustrated example is in communication with main memory 714, 716, which includes a volatile memory 714 and a non-volatile memory 716, by a bus 718. The volatile memory 714 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 716 may be implemented by flash memory and/or any other desired type of memory device. Access to the main memory 714, 716 of the illustrated example is controlled by a memory controller 717. In some examples, the memory controller 717 may be implemented by one or more integrated circuits, logic circuits, microcontrollers from any desired family or manufacturer, or any other type of circuitry to manage the flow of data going to and from the main memory 714, 716.

The programmable circuitry platform 700 of the illustrated example also includes interface circuitry 720. The interface circuitry 720 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 722 are connected to the interface circuitry 720. The input device(s) 722 permit(s) a user (e.g., a human user, a machine user, etc.) to enter data and/or commands into the programmable circuitry 712. The input device(s) 722 can be implemented by, for example, an audio sensor, a microphone, a camera (still or video), a keyboard, a button, a mouse, a touchscreen, a trackpad, a trackball, an isopoint device, and/or a voice recognition system.

One or more output devices 724 are also connected to the interface circuitry 720 of the illustrated example. The output device(s) 724 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 720 of the illustrated example, thus, typically includes a graphics driver card, a graphics driver chip, and/or graphics processor circuitry such as a GPU.

The interface circuitry 720 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 726. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 700 of the illustrated example also includes one or more mass storage discs or devices 728 to store firmware, software, and/or data. Examples of such mass storage discs or devices 728 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine-readable instructions 732, which may be implemented by the machine-readable instructions of FIGS. 4-6, may be stored in the mass storage device 728, in the volatile memory 714, in the non-volatile memory 716, and/or on at least one non-transitory computer-readable storage medium such as a CD or DVD which may be removable.

FIG. 8 is a block diagram of an example implementation of the programmable circuitry 712 of FIG. 7. In this example, the programmable circuitry 712 of FIG. 7 is implemented by a microprocessor 800. For example, the microprocessor 800 may be a general-purpose microprocessor (e.g., general-purpose microprocessor circuitry). The microprocessor 800 executes some or all of the machine-readable instructions of the flowcharts of FIGS. 4-6 to effectively instantiate the circuitry of FIG. 2 as logic circuits to perform operations corresponding to those machine-readable instructions. In some such examples, the circuitry of FIG. 2 is instantiated by the hardware circuits of the microprocessor 800 in combination with the machine-readable instructions. For example, the microprocessor 800 may be implemented by multi-core hardware circuitry such as a CPU, a DSP, a GPU, an XPU, etc. Although it may include any number of example cores 802 (e.g., 1 core), the microprocessor 800 of this example is a multi-core semiconductor device including N cores. The cores 802 of the microprocessor 800 may operate independently or may cooperate to execute machine-readable instructions. For example, machine code corresponding to a firmware program, an embedded software program, or a software program may be executed by one of the cores 802 or may be executed by multiple ones of the cores 802 at the same or different times. In some examples, the machine code corresponding to the firmware program, the embedded software program, or the software program is split into threads and executed in parallel by two or more of the cores 802. The software program may correspond to a portion or all of the machine-readable instructions and/or operations represented by the flowcharts of FIGS. 4-6.

The cores 802 may communicate by a first example bus 804. In some examples, the first bus 804 may be implemented by a communication bus to effectuate communication associated with one(s) of the cores 802. For example, the first bus 804 may be implemented by at least one of an Inter-Integrated Circuit (I2C) bus, a Serial Peripheral Interface (SPI) bus, a PCI bus, or a PCIe bus. Additionally or alternatively, the first bus 804 may be implemented by any other type of computing or electrical bus. The cores 802 may obtain data, instructions, and/or signals from one or more external devices by example interface circuitry 806. The cores 802 may output data, instructions, and/or signals to the one or more external devices by the interface circuitry 806. Although the cores 802 of this example include example local memory 820 (e.g., Level 1 (L1) cache that may be split into an L1 data cache and an L1 instruction cache), the microprocessor 800 also includes example shared memory 810 that may be shared by the cores (e.g., Level 2 (L2 cache)) for high-speed access to data and/or instructions. Data and/or instructions may be transferred (e.g., shared) by writing to and/or reading from the shared memory 810. The local memory 820 of each of the cores 802 and the shared memory 810 may be part of a hierarchy of storage devices including multiple levels of cache memory and the main memory (e.g., the main memory 714, 716 of FIG. 7). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 802 may be referred to as a CPU, DSP, GPU, etc., or any other type of hardware circuitry. Each core 802 includes control unit circuitry 814, arithmetic and logic (AL) circuitry (sometimes referred to as an ALU) 816, a plurality of registers 818, the local memory 820, and a second example bus 822. Other structures may be present. For example, each core 802 may include vector unit circuitry, single instruction multiple data (SIMD) unit circuitry, load/store unit (LSU) circuitry, branch/jump unit circuitry, floating-point unit (FPU) circuitry, etc. The control unit circuitry 814 includes semiconductor-based circuits structured to control (e.g., coordinate) data movement within the corresponding core 802. The AL circuitry 816 includes semiconductor-based circuits structured to perform one or more mathematic and/or logic operations on the data within the corresponding core 802. The AL circuitry 816 of some examples performs integer based operations. In other examples, the AL circuitry 816 also performs floating-point operations. In yet other examples, the AL circuitry 816 may include first AL circuitry that performs integer-based operations and second AL circuitry that performs floating-point operations. In some examples, the AL circuitry 816 may be referred to as an Arithmetic Logic Unit (ALU).

The registers 818 are semiconductor-based structures to store data and/or instructions such as results of one or more of the operations performed by the AL circuitry 816 of the corresponding core 802. For example, the registers 818 may include vector register(s), SEID register(s), general-purpose register(s), flag register(s), segment register(s), machine-specific register(s), instruction pointer register(s), control register(s), debug register(s), memory management register(s), machine check register(s), etc. The registers 818 may be arranged in a bank as shown in FIG. 8. Alternatively, the registers 818 may be organized in any other arrangement, format, or structure, such as by being distributed throughout the core 802 to shorten access time. The second bus 822 may be implemented by at least one of an I2C bus, a SPI bus, a PCI bus, or a PCIe bus.

Each core 802 and/or, more generally, the microprocessor 800 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 800 is a semiconductor device fabricated to include many transistors interconnected to implement the structures described above in one or more integrated circuits (ICs) contained in one or more packages.

The microprocessor 800 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 800, in the same chip package as the microprocessor 800 and/or in one or more separate packages from the microprocessor 800.

FIG. 9 is a block diagram of another example implementation of the programmable circuitry 712 of FIG. 7. In this example, the programmable circuitry 712 is implemented by FPGA circuitry 900. For example, the FPGA circuitry 900 may be implemented by an FPGA. The FPGA circuitry 900 can be used, for example, to perform operations that could otherwise be performed by the example microprocessor 800 of FIG. 8 executing corresponding machine-readable instructions. However, once configured, the FPGA circuitry 900 instantiates the operations and/or functions corresponding to the machine-readable instructions in hardware and, thus, can often execute the operations/functions faster than they could be performed by a general-purpose microprocessor executing the corresponding software.

More specifically, in contrast to the microprocessor 800 of FIG. 8 described above (which is a general purpose device that may be programmed to execute some or all of the machine-readable instructions represented by the flowchart(s) of FIGS. 4-6 but whose interconnections and logic circuitry are fixed once fabricated), the FPGA circuitry 900 of the example of FIG. 9 includes interconnections and logic circuitry that may be configured, structured, programmed, and/or interconnected in different ways after fabrication to instantiate, for example, some or all of the operations/functions corresponding to the machine-readable instructions represented by the flowchart(s) of FIGS. 4-6. In particular, the FPGA circuitry 900 may be thought of as an array of logic gates, interconnections, and switches. The switches can be programmed to change how the logic gates are interconnected by the interconnections, effectively forming one or more dedicated logic circuits (unless and until the FPGA circuitry 900 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 4-6. As such, the FPGA circuitry 900 may be configured and/or structured to effectively instantiate some or all of the operations/functions corresponding to the machine-readable instructions of the flowchart(s) of FIGS. 4-6 as dedicated logic circuits to perform the operations/functions corresponding to those software instructions in a dedicated manner analogous to an ASIC. Therefore, the FPGA circuitry 900 may perform the operations/functions corresponding to the some or all of the machine-readable instructions of FIGS. 4-6 faster than the general-purpose microprocessor can execute the same.

In the example of FIG. 9, the FPGA circuitry 900 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 900 of FIG. 9 may access and/or load the binary file to cause the FPGA circuitry 900 of FIG. 9 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 900 of FIG. 9 to cause configuration and/or structuring of the FPGA circuitry 900 of FIG. 9, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 900 of FIG. 9 may access and/or load the binary file to cause the FPGA circuitry 900 of FIG. 9 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 900 of FIG. 9 to cause configuration and/or structuring of the FPGA circuitry 900 of FIG. 9, or portion(s) thereof.

The FPGA circuitry 900 of FIG. 9, includes example input/output (I/O) circuitry 902 to obtain and/or output data to/from example configuration circuitry 904 and/or external hardware 906. For example, the configuration circuitry 904 may be implemented by interface circuitry that may obtain a binary file, which may be implemented by a bit stream, data, and/or machine-readable instructions, to configure the FPGA circuitry 900, or portion(s) thereof. In some such examples, the configuration circuitry 904 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 906 may be implemented by external hardware circuitry. For example, the external hardware 906 may be implemented by the microprocessor 800 of FIG. 8.

The FPGA circuitry 900 also includes an array of example logic gate circuitry 908, a plurality of example configurable interconnections 910, and example storage circuitry 912. The logic gate circuitry 908 and the configurable interconnections 910 are configurable to instantiate one or more operations/functions that may correspond to at least some of the machine-readable instructions of FIGS. 4-6 and/or other desired operations. The logic gate circuitry 908 shown in FIG. 9 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 908 to enable configuration of the electrical structures and/or the logic gates to form circuits to perform desired operations/functions. The logic gate circuitry 908 may include other electrical structures such as look-up tables (LUTs), registers (e.g., flip-flops or latches), multiplexers, etc.

The configurable interconnections 910 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 908 to program desired logic circuits.

The storage circuitry 912 of the illustrated example is structured to store result(s) of the one or more of the operations performed by corresponding logic gates. The storage circuitry 912 may be implemented by registers or the like. In the illustrated example, the storage circuitry 912 is distributed amongst the logic gate circuitry 908 to facilitate access and increase execution speed.

The example FPGA circuitry 900 of FIG. 9 also includes example dedicated operations circuitry 914. In this example, the dedicated operations circuitry 914 includes special purpose circuitry 916 that may be invoked to implement commonly used functions to avoid the need to program those functions in the field. Examples of such special purpose circuitry 916 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 900 may also include example general purpose programmable circuitry 918 such as an example CPU 920 and/or an example DSP 922. Other general purpose programmable circuitry 918 may additionally or alternatively be present such as a GPU, an XPU, etc., that can be programmed to perform other operations.

Although FIGS. 8 and 9 illustrate two example implementations of the programmable circuitry 712 of FIG. 7, many other approaches are contemplated. For example, FPGA circuitry may include an on-board CPU, such as one or more of the example CPU 920 of FIG. 8. Therefore, the programmable circuitry 712 of FIG. 7 may additionally be implemented by combining at least the example microprocessor 800 of FIG. 8 and the example FPGA circuitry 900 of FIG. 9. In some such hybrid examples, one or more cores 802 of FIG. 8 may execute a first portion of the machine-readable instructions represented by the flowchart(s) of FIGS. 4-6 to perform first operation(s)/function(s), the FPGA circuitry 900 of FIG. 9 may be configured and/or structured to perform second operation(s)/function(s) corresponding to a second portion of the machine-readable instructions represented by the flowcharts of FIG. 4-6, and/or an ASIC may be configured and/or structured to perform third operation(s)/function(s) corresponding to a third portion of the machine-readable instructions represented by the flowcharts of FIGS. 4-6.

It should be understood that some or all of the circuitry of FIG. 2 may, thus, be instantiated at the same or different times. For example, same and/or different portion(s) of the microprocessor 800 of FIG. 8 may be programmed to execute portion(s) of machine-readable instructions at the same and/or different times. In some examples, same and/or different portion(s) of the FPGA circuitry 900 of FIG. 9 may be configured and/or structured to perform operations/functions corresponding to portion(s) of machine-readable instructions at the same and/or different times.

In some examples, some or all of the circuitry of FIG. 2 may be instantiated, for example, in one or more threads executing concurrently and/or in series. For example, the microprocessor 800 of FIG. 8 may execute machine-readable instructions in one or more threads executing concurrently and/or in series. In some examples, the FPGA circuitry 900 of FIG. 9 may be configured and/or structured to carry out operations/functions concurrently and/or in series. Moreover, in some examples, some or all of the circuitry of FIG. 2 may be implemented within one or more virtual machines and/or containers executing on the microprocessor 800 of FIG. 8.

In some examples, the programmable circuitry 712 of FIG. 7 may be in one or more packages. For example, the microprocessor 800 of FIG. 8 and/or the FPGA circuitry 900 of FIG. 9 may be in one or more packages. In some examples, an XPU may be implemented by the programmable circuitry 712 of FIG. 7, which may be in one or more packages. For example, the XPU may include a CPU (e.g., the microprocessor 800 of FIG. 8, the CPU 920 of FIG. 9, etc.) in one package, a DSP (e.g., the DSP 922 of FIG. 9) in another package, a GPU in yet another package, and an FPGA (e.g., the FPGA circuitry 900 of FIG. 9) in still yet another package.

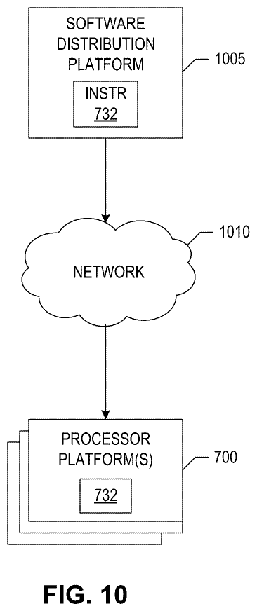

A block diagram illustrating an example software distribution platform 1005 to distribute software such as the example machine-readable instructions 732 of FIG. 7 to other hardware devices (e.g., hardware devices owned and/or operated by third parties from the owner and/or operator of the software distribution platform) is illustrated in FIG. 10. The example software distribution platform 1005 may be implemented by any computer server, data facility, cloud service, etc., capable of storing and transmitting software to other computing devices. The third parties may be customers of the entity owning and/or operating the software distribution platform 1005. For example, the entity that owns and/or operates the software distribution platform 1005 may be a developer, a seller, and/or a licensor of software such as the example machine-readable instructions 732 of FIG. 7. The third parties may be consumers, users, retailers, OEMs, etc., who purchase and/or license the software for use and/or re-sale and/or sub-licensing. In the illustrated example, the software distribution platform 1005 includes one or more servers and one or more storage devices. The storage devices store the machine-readable instructions 732, which may correspond to the example machine-readable instructions of FIGS. 4-6, as described above. The one or more servers of the example software distribution platform 1005 are in communication with an example network 1010, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine-readable instructions 732 from the software distribution platform 1005. For example, the software, which may correspond to the example machine-readable instructions of FIG. 4-6, may be downloaded to the example programmable circuitry platform 700, which is to execute the machine-readable instructions 732 to implement the noise seed selection circuitry 110. In some examples, one or more servers of the software distribution platform 1005 periodically offer, transmit, and/or force updates to the software (e.g., the example machine-readable instructions 732 of FIG. 7) to ensure improvements, patches, updates, etc., are distributed and applied to the software at the end user devices. Although referred to as software above, the distributed “software” could alternatively be firmware.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities, etc., the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities, etc., the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

As used herein, connection references (e.g., attached, coupled, connected, and joined) may include intermediate members between the elements referenced by the connection reference and/or relative movement between those elements unless otherwise indicated. As such, connection references do not necessarily infer that two elements are directly connected and/or in fixed relation to each other. As used herein, stating that any part is in “contact” with another part is defined to mean that there is no intermediate part between the two parts.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified herein.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

From the foregoing, it will be appreciated that example systems, apparatus, articles of manufacture, and methods have been disclosed that implement attention-based noise seed selection for video diffusion models. Disclosed systems, apparatus, articles of manufacture, and methods improve the efficiency of using a computing device by implementing noise seed selection for video diffusion models based on attention data extracted from the models with nominal computation overhead, without model retraining and/or without the use of auxiliary models. Furthermore, examples of attention-based noise seed selection, as disclosed herein, identify reliable noise seeds before full denoising and provide stable object trajectories without any lookahead computation or auxiliary evaluators. Disclosed systems, apparatus, articles of manufacture, and methods are accordingly directed to one or more improvement(s) in the operation of a machine such as a computer or other electronic and/or mechanical device.

Further examples and combinations thereof include the following. Example 1 includes an apparatus comprising interface circuitry, machine-readable instructions, and at least one programmable circuit to be programmed based on the machine-readable instructions to obtain sets of one or more attention maps respectively associated with corresponding noise seeds from one or more attention layers of a trained video diffusion model, ones of the sets of one or more attention maps based on respective executions of the trained video diffusion model for a number of diffusion iterations after initialization of the trained video diffusion model with the corresponding noise seeds, select at least one of the noise seeds based on the sets of one or more attention maps, and cause execution of the trained video diffusion model based on the selected at least one of the noise seeds to infer an output video.

Example 2 includes the apparatus of example 1, wherein the number of diffusion iterations is an initial number of iterations that is less than a total number of diffusions iterations performed by the trained video diffusion model to infer the output video.

Example 3 includes the apparatus of example 1 or example 2, wherein ones of the sets of one or more attention maps include a plurality of attention maps corresponding respectively to a plurality of attention layers of the trained video diffusion model.

Example 4 includes the apparatus of any one of examples 1 to 3, wherein one or more of the at least one programmable circuit is to determine respective scores associated with the corresponding noise seeds based on the sets of one or more attention maps, and select the at least one of the noise seeds based on the scores.

Example 5 includes the apparatus of example 4, wherein the sets of one or more attention maps are sets of two or more first attention maps, and one or more of the at least one programmable circuit is to combine the two or more first attention maps in the respective sets of two or more first attention maps to determine respective second attention maps respectively associated with the corresponding noise seeds, and determine the respective scores based on the second attention maps.

Example 6 includes the apparatus of example 5, wherein one or more of the at least one programmable circuit is to average the two or more first attention maps in the respective sets of two or more first attention maps to determine the respective second attention maps.

Example 7 includes the apparatus of example 5 or example 6, wherein one or more of the at least one programmable circuit is to determine pairwise distances among the second attention maps, and determine the respective scores based on the distances.

Example 8 includes the apparatus of example 5 or example 6, wherein one or more of the at least one programmable circuit is to determine distances between respective ones of the second attention maps and corresponding group means of remaining ones of the second attention maps, and determine the respective scores based on the distances.

Example 9 includes the apparatus of example 5 or example 6, wherein one or more of the at least one programmable circuit is to determine the respective scores as respective cosine similarity scores between respective ones of the second attention maps and corresponding group means of remaining ones of the second attention maps.

Example 10 includes the apparatus of example 9, wherein the selected at least one of the noise seeds corresponds to a largest one or more of the cosine similarity scores.

Example 11 includes the apparatus of any one of examples 1 to 10, wherein one or more of the at least one programmable circuit is to obtain the respective sets of one or more attention maps based on a token region corresponding to an inverse of an object mask.

Example 12 includes the apparatus of example 11, wherein the object mask corresponds to an object to be included in the output video, and one or more of the at least one programmable circuit is to cause the object mask to be input to the trained video diffusion model.

Example 13 includes the apparatus of any one of examples 1 to 3, wherein the sets of one or more attention maps are sets of two or more first attention maps, and one or more of the at least one programmable circuit is to combine the two or more first attention maps in the respective sets of two or more first attention maps to determine respective second attention maps respectively associated with the corresponding noise seeds, and cause display of one or more of the second attention maps, and select the at least one of the noise seeds based on user input obtained after the display of the one or more of the second attention maps.

Example 14 includes at least one non-transitory computer-readable storage medium comprising computer-readable instructions to cause at least one programmable circuit to at least extract sets of one or more attention maps respectively associated with corresponding noise seeds from one or more attention layers of a trained video diffusion model, ones of the sets of one or more attention maps based on respective executions of the trained video diffusion model for a number of diffusion iterations after initialization of the trained video diffusion model with the corresponding noise seeds, select at least one of the noise seeds based on the sets of one or more attention maps, and cause execution of the trained video diffusion model based on the selected at least one of the noise seeds to infer an output video.

Example 15 includes the at least one non-transitory computer-readable storage medium of example 14, wherein the number of diffusion iterations is an initial number of iterations that is less than a total number of diffusions iterations performed by the trained video diffusion model to infer the output video.

Example 16 includes the at least one non-transitory computer-readable storage medium of example 14 or example 15, wherein the sets of one or more attention maps are sets of two or more first attention maps, and the instructions are to cause one or more of the at least one programmable circuit to combine the two or more first attention maps in the respective sets of two or more first attention maps to determine respective second attention maps respectively associated with the corresponding noise seeds, and determine respective scores associated with the corresponding noise seeds based on the second attention maps, and select the at least one of the noise seeds based on the scores.

Example 17 includes the at least one non-transitory computer-readable storage medium of example 16, wherein the instructions are to cause one or more of the at least one programmable circuit to determine distances between respective ones of the second attention maps and corresponding group means of remaining ones of the second attention maps, and determine the respective scores based on the distances.

Example 18 includes a system comprising means for executing a trained video diffusion model, and means for selecting an initial noise seed for the trained video diffusion model, the means for selecting to extract sets of one or more attention maps associated respectively with corresponding candidate noise seeds from one or more attention layers of the trained video diffusion model, ones of the sets of one or more attention maps based on respective executions of the trained video diffusion model for a number of diffusion iterations after initialization of the trained video diffusion model with the corresponding candidate noise seeds, select the initial noise seed from the candidate noise seeds based on the sets of one or more attention maps, and cause the means for executing to execute of the trained video diffusion model based on the initial noise seed to infer an output video.

Example 19 includes the system of example 18, wherein the number of diffusion iterations is an initial number of iterations that is less than a total number of diffusions iterations performed by the trained video diffusion model to infer the output video.

Example 20 includes the system of example 18 or example 19, wherein the means for selecting is to extract the respective sets of one or more attention maps based on a token region corresponding to an inverse of an object mask.

Example 21 includes a method comprising obtaining sets of one or more attention maps respectively associated with corresponding noise seeds from one or more attention layers of a trained video diffusion model, ones of the sets of one or more attention maps based on respective executions of the trained video diffusion model for a number of diffusion iterations after initialization of the trained video diffusion model with the corresponding noise seeds, selecting at least one of the noise seeds based on the sets of one or more attention maps, and causing execution of the trained video diffusion model based on the selected at least one of the noise seeds to infer an output video.

Example 22 includes the method of example 21, wherein the number of diffusion iterations is an initial number of iterations that is less than a total number of diffusions iterations performed by the trained video diffusion model to infer the output video.

Example 23 includes the method of example 21 or example 22, wherein ones of the sets of one or more attention maps include a plurality of attention maps corresponding respectively to a plurality of attention layers of the trained video diffusion model.

Example 24 includes the method of any one of examples 21 to 23, including determining respective scores associated with the corresponding noise seeds based on the sets of one or more attention maps, and selecting the at least one of the noise seeds based on the scores.

Example 25 includes the method of example 24, wherein the sets of one or more attention maps are sets of two or more first attention maps, and including combining the two or more first attention maps in the respective sets of two or more first attention maps to determine respective second attention maps respectively associated with the corresponding noise seeds, and determining the respective scores based on the second attention maps.

Example 26 includes the method of example 25, wherein the combining includes averaging the two or more first attention maps in the respective sets of two or more first attention maps to determine the respective second attention maps.

Example 27 includes the method of example 25 or example 26, wherein the determining of the respective scores includes determining pairwise distances among the second attention maps, and determining the respective scores based on the distances.

Example 28 includes the method of example 25 or example 26, wherein the determining of the respective scores includes determining distances between respective ones of the second attention maps and corresponding group means of remaining ones of the second attention maps, and determining the respective scores based on the distances.

Example 29 includes the method of example 25 or example 26, wherein the determining of the respective scores includes determining the respective scores as respective cosine similarity scores between respective ones of the second attention maps and corresponding group means of remaining ones of the second attention maps.

Example 30 includes the method of example 29, wherein the selected at least one of the noise seeds corresponds to a largest one or more of the cosine similarity scores.

Example 31 includes the method of any one of examples 21 to 30, wherein the obtaining of the sets of one or more attention maps including obtaining the respective sets of one or more attention maps based on a token region corresponding to an inverse of an object mask.

Example 32 includes the method of example 31, wherein the object mask corresponds to an object to be included in the output video, and including causing the object mask to be input to the trained video diffusion model.

Example 33 includes the method of any one of examples 21 to 23, wherein the sets of one or more attention maps are sets of two or more first attention maps, and including combining the two or more first attention maps in the respective sets of two or more first attention maps to determine respective second attention maps respectively associated with the corresponding noise seeds, and causing display of one or more of the second attention maps, and selecting the at least one of the noise seeds based on user input obtained after the displaying of the one or more of the second attention maps.

Example 34 includes at least one machine-readable medium comprising machine-readable instructions to cause at least one programmable circuit to perform the method of any one of examples 21 to example 33.

Example 35 includes an apparatus to perform the method of any one of examples 21 to example 33.

Example 36 includes a method performed by any one of the apparatus of examples 1 to example 13.

Example 37 includes at least one machine-readable medium comprising the machine-readable instructions of any one of the apparatus of examples 1 to example 13.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus comprising:
interface circuitry;
machine-readable instructions; and
at least one programmable circuit to be programmed based on the machine-readable instructions to:
obtain sets of one or more attention maps respectively associated with corresponding noise seeds from one or more attention layers of a trained video diffusion model, ones of the sets of one or more attention maps based on respective executions of the trained video diffusion model for a number of diffusion iterations after initialization of the trained video diffusion model with the corresponding noise seeds;
select at least one of the noise seeds based on the sets of one or more attention maps; and
cause execution of the trained video diffusion model based on the selected at least one of the noise seeds to infer an output video.

2. The apparatus of claim 1, wherein the number of diffusion iterations is an initial number of iterations that is less than a total number of diffusions iterations performed by the trained video diffusion model to infer the output video.

3. The apparatus of claim 1, wherein ones of the sets of one or more attention maps include a plurality of attention maps corresponding respectively to a plurality of attention layers of the trained video diffusion model.

4. The apparatus of claim 1, wherein one or more of the at least one programmable circuit is to:
determine respective scores associated with the corresponding noise seeds based on the sets of one or more attention maps; and
select the at least one of the noise seeds based on the scores.

5. The apparatus of claim 4, wherein the sets of one or more attention maps are sets of two or more first attention maps, and one or more of the at least one programmable circuit is to:
combine the two or more first attention maps in the respective sets of two or more first attention maps to determine respective second attention maps respectively associated with the corresponding noise seeds; and
determine the respective scores based on the second attention maps.

6. The apparatus of claim 5, wherein one or more of the at least one programmable circuit is to average the two or more first attention maps in the respective sets of two or more first attention maps to determine the respective second attention maps.

7. The apparatus of claim 5, wherein one or more of the at least one programmable circuit is to:
determine pairwise distances among the second attention maps; and
determine the respective scores based on the distances.

8. The apparatus of claim 5, wherein one or more of the at least one programmable circuit is to:
determine distances between respective ones of the second attention maps and corresponding group means of remaining ones of the second attention maps; and
determine the respective scores based on the distances.

9. The apparatus of claim 5, wherein one or more of the at least one programmable circuit is to determine the respective scores as respective cosine similarity scores between respective ones of the second attention maps and corresponding group means of remaining ones of the second attention maps.

10. The apparatus of claim 9, wherein the selected at least one of the noise seeds corresponds to a largest one or more of the cosine similarity scores.

11. The apparatus of claim 1, wherein one or more of the at least one programmable circuit is to obtain the respective sets of one or more attention maps based on a token region corresponding to an inverse of an object mask.

12. The apparatus of claim 11, wherein the object mask corresponds to an object to be included in the output video, and one or more of the at least one programmable circuit is to cause the object mask to be input to the trained video diffusion model.

13. The apparatus of claim 1, wherein the sets of one or more attention maps are sets of two or more first attention maps, and one or more of the at least one programmable circuit is to:
combine the two or more first attention maps in the respective sets of two or more first attention maps to determine respective second attention maps respectively associated with the corresponding noise seeds; and
cause display of one or more of the second attention maps; and
select the at least one of the noise seeds based on user input obtained after the display of the one or more of the second attention maps.

14. At least one non-transitory computer-readable storage medium comprising computer-readable instructions to cause at least one programmable circuit to at least:
extract sets of one or more attention maps respectively associated with corresponding noise seeds from one or more attention layers of a trained video diffusion model, ones of the sets of one or more attention maps based on respective executions of the trained video diffusion model for a number of diffusion iterations after initialization of the trained video diffusion model with the corresponding noise seeds;
select at least one of the noise seeds based on the sets of one or more attention maps; and
cause execution of the trained video diffusion model based on the selected at least one of the noise seeds to infer an output video.

15. The at least one non-transitory computer-readable storage medium of claim 14, wherein the number of diffusion iterations is an initial number of iterations that is less than a total number of diffusions iterations performed by the trained video diffusion model to infer the output video.

16. The at least one non-transitory computer-readable storage medium of claim 14, wherein the sets of one or more attention maps are sets of two or more first attention maps, and the instructions are to cause one or more of the at least one programmable circuit to:
combine the two or more first attention maps in the respective sets of two or more first attention maps to determine respective second attention maps respectively associated with the corresponding noise seeds; and
determine respective scores associated with the corresponding noise seeds based on the second attention maps; and
select the at least one of the noise seeds based on the scores.

17. The at least one non-transitory computer-readable storage medium of claim 16, wherein the instructions are to cause one or more of the at least one programmable circuit to:
determine distances between respective ones of the second attention maps and corresponding group means of remaining ones of the second attention maps; and
determine the respective scores based on the distances.

18. A system comprising:
means for executing a trained video diffusion model; and
means for selecting an initial noise seed for the trained video diffusion model, the means for selecting to:
extract sets of one or more attention maps associated respectively with corresponding candidate noise seeds from one or more attention layers of the trained video diffusion model, ones of the sets of one or more attention maps based on respective executions of the trained video diffusion model for a number of diffusion iterations after initialization of the trained video diffusion model with the corresponding candidate noise seeds;
select the initial noise seed from the candidate noise seeds based on the sets of one or more attention maps; and
cause the means for executing to execute of the trained video diffusion model based on the initial noise seed to infer an output video.

19. The system of claim 18, wherein the number of diffusion iterations is an initial number of iterations that is less than a total number of diffusions iterations performed by the trained video diffusion model to infer the output video.

20. The system of claim 18, wherein the means for selecting is to extract the respective sets of one or more attention maps based on a token region corresponding to an inverse of an object mask.
